(19) United States
(12) Patent Application Publication
(10) Pub. No.: US 2009/0228340 A1
(43) Pub. Date: Sep. 10, 2009

(54) System and Method for Electronic Feedback for Transaction Triggers

(75) Inventor: James J. Bohannon, Pleasanton, CA (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: MYPOINTS.COM INC., San Francisco, CA (US)

(21) Appl. No.: 12/400,648

(22) Filed: Mar. 9, 2009

Related U.S. Application Data
(60) Provisional application No. 61/034,774, filed on Mar. 7, 2008.

(51) Int. Cl. G06Q 30/00; G06F 15/16; G06Q 10/00

(52) U.S. Cl. 705/10; 705/14; 709/204; 705/30

(57) ABSTRACT

A method, in a computer system, for processing messages descriptive of an interaction between a user of the computer system and a third party according to a predefined manner includes receiving an electronic message, such that the electronic message includes interaction information associated with an interaction between the user and the third party; verifying integrity of the electronic message; identifying a rule associated with the interaction, including identifying a condition associated with the rule identifying an action to be performed if the condition is met; and performing the action based on the rule and the interaction information in the electronic message if the condition is met.

### CROSS-REFERENCE TO RELATED APPLICATION

This application claims the benefit of U.S. Provisional Patent App. No. 61/034,774 entitled “System and Method for Electronic Feedback for Transaction Triggers,” filed Mar. 7, 2008, the disclosure of which is hereby expressly incorporated herein by reference.

### TECHNICAL FIELD

The following disclosure relates to an information management system and, more particularly, to a system and method for receiving electronic feedback generated in response to detecting a user transaction.

### BACKGROUND

Merchants, banking institutions, publishers of periodicals, survey collectors, and other providers of products and services frequently award customers for participating in promotional campaigns or surveys, accepting subscription or purchase offers, or simply making business-related inquires. Such awards may range from relatively inexpensive tokens of customer appreciation, such as small product samples, to substantial discounts on products or services, including direct monetary credit. Understandably, the providers of awards frequently require a proof of purchase or participation to prevent fraud and reduce the risk of incorrectly crediting customers. One commonly known example of such proof is a retail store receipt, which a product manufacturer may require prior to issuing an award to a customer. Another equally well known example is a strip of paper detachable from a cigarette pack which includes text and/or images indicating that the strip comes from a properly purchased product. Although the specific requirements regarding the acceptable forms of proof vary widely among various industries, a proof of purchase or participation typically identifies the date and time on which the required activity took place, the type of required activity, such as purchase, survey participation, etc., and some measurement of participation, such as purchase price, amount of time spent, number of questions answered, etc. In some cases, the proof additionally identifies the customer. In others, the customer must also produce evidence of participation in a particular campaign, such as a paper coupon identifying the promotion, for example.

With the advent of e-commerce, many of the providers of products and information have begun to provide electronic feedback for purchases and other types of customer transactions. For example, an online retailer may send an e-mail confirmation to a customer who has recently made a purchase. As is well known, online retailers maintain interactive web sites operating as virtual stores. However, the online retailers (also known a e-tailers) currently do not rely on electronic receipts in general and e-mail confirmations in particular for purchase verification. Instead, electronic confirmation messages serve mostly informational purposes. If, for example, a product purchased from an e-tailer fails to arrive at the specified address and the customer requests a refund, the merchant can typically look for the corresponding transaction in the merchant's own database. Thus, an e-tailer typically sees no need for the customer to submit or forward the electronic confirmation message back to the e-tailer. For this reason, and also because the ephemeral nature of electronic messaging is generally conducive to forgery, the online providers of products, services, and information do not use electronic confirmation messages as valid proofs of purchase or participation. Furthermore, online retailers (or other online providers of products and services) will typically include a transaction ID in an e-mail confirmation message which can be used to look up a consumer's transaction. While the e-mail itself might be forged, the transaction ID will typically be a large number that cannot practically be forged. The retailer may use the transaction ID to look up the transaction in its database. However, in order for a third party (who would fulfill the promised award or discount or refund) to verify the authenticity of the transaction using only the transaction ID, the third-party would need access to the online retailer's database, something which might not be practical or acceptable to the online retailer.

Meanwhile, e-commerce has brought about an even greater number of promotions and advertisement campaigns which involve awarding customers for purchases made or for participation in a predefined activity. In general, e-commerce relates to various forms of commercial activity carried out over the Internet, or World Wide Web. As is known, users of the World Wide Web distributed computing environment may freely send and retrieve data across long distances and between remote computing devices. The Web, implemented on the Internet, presents users with documents called “web pages” that may contain information as well as “hyperlinks” which allow the users to select and connect to related web sites. The web pages may be stored on remote computing devices, or servers, as hypertext-encoded files. The servers use Hyper Text Transfer Protocol (HTTP), or other protocols to transfer the encoded files to client users. Many users may remotely access the web sites stored on network-connected computing devices from a personal computer (PC) through a browser application running on the PC.

The browser application may act as an interface between user PCs and remote computing devices and may allow the user to view or access data that may reside on any remote computing device connected to the PC through the World Wide Web and browser interface. Typically, the local user PC and the remote computing device may represent a client and a server, respectively. Further, the local user PC or client may access Web data without knowing the source of the data or its physical location and publication of Web data may be accomplished by simply assigning to data a Uniform Resource Locator (URL) that refers to the local file. To a local client, the Web may appear as a single, coherent data delivery and publishing system in which individual differences between other clients or servers may be hidden.

Needless to say, the proliferation of inexpensive computers and affordable access to the Internet have resulted in the expansion of most markets and, in most cases, has significantly increased competitiveness of retailers. As a result, many of the online providers of products and services seek additional help in identifying potential customers or campaign participants (because these providers typically operate own web sites, they shall be referred to hereinafter as “web site proprietors”). For example, e-tailers may rely on advertisement banners displayed on a web site offering specialized news to target those who, by virtue of visiting the particular news site, are more likely to purchase a particular product. As another example, some web site proprietors purchase demographic information from an information gathering service or, alternatively, rely on the information gathering service to conduct highly focused, precisely targeted advertisement campaigns or to otherwise direct users to the proprietors' sites.

A system may provide web site proprietors with web site user demographics information and is generally described in U.S. Pat. No. 7,240,022, “DEMOGRAPHIC INFORMATION GATHERING AND INCENTIVE AWARD SYSTEM AND METHOD” to Bistriceanu et al., the entire disclosure of which is hereby incorporated by reference. Generally, the system may include users, web site proprietors, and an enterprise system hosting a central web site. The users may register with the central web site and may earn “points” for performing specific on- or off-line tasks in exchange for disclosing their demographic information during registration. The users may then redeem their earned points at participating proprietors for merchandise or services. Generally, the central web site manages the system by performing a number of tasks including: maintaining all user demographic information, tracking user point totals, and awarding points according to specific, proprietor-defined rules.

Web site proprietors, and clients of an information gathering system in particular, may display various offers to web site visitors. Typically, offers are displayed as advertisement banners, hyperlinks, or interactive animations rendered in HTML, JAVA, JAVASCRIPT, and other software tools widely available to web content developers. Because many web site proprietors offer a large variety of products, which may be in the form of goods or services, the proprietors may want to focus the advertisements in order to achieve a higher rate of “conversion,” or of web site visitors actually purchasing the offered products, clicking on the advertisement banners, following text-only hyperlinks, and similarly responding to the offers rendered on the page. In other words, web site proprietors generally attempt to use the information available from the visitors to the sites operated by the proprietors in order to “target” visitors for a particular type of product.

Moreover, targeted information may not be limited to advertisement. For instance, a web site proprietor operating a weather service may display information specific to the geographic area from which a particular visitor is accessing the web site. As another example, some web sites provide interactive services for which web site proprietors retain user-specific information in databases, such as banks offering online services to bank customers. In this case, a web server servicing online requests may similarly render user-specific information, such as the name of the user, his or her account balance, and a list of nearest bank locations to a web site visitor after ascertaining and confirming his or her identity through a login process.

Because the system awards points redeemable for products and services, this and similar systems require a safe and reliable method of obtaining information related to the various member activities for which the points are allocated. Of course, awarding an insufficient amount of points may lead to customer dissatisfaction while awarding extra points as a result of error or intentional fraud may result in a significant financial loss. Moreover, because the system may work in cooperation with many web site proprietors offering a wide range of products and services, the method of collecting information related to member activity must be compatible with each web site proprietor, and preferably should require a minimum degree of intrusion into the respective systems of the participating web site proprietors.

### BRIEF DESCRIPTION OF THE DRAWINGS

FIG. 1 is a diagram of one example of a network in which the system and method described herein may be implemented.

FIG. 2 is a diagram of one example of a general computing device that may operate in accordance with the claims.

FIG. 3 is a diagram of one example of an enterprise system including two groups of servers, a web server, and a firewall as connected to the network of FIG. 1.

FIG. 4 is a flowchart describing a method of one example of using the system of FIG. 3 to award points in exchange for demographics information.

FIG. 5 is another diagram of one example of an enterprise system including a load balancer, a plurality of member server groups, and a single administrative server group.

FIG. 6 is another flowchart describing a method of one example of using the systems of FIGS. 5, 7, and 8 to award points in exchange for demographics information.

FIG. 7 is another diagram of one example of an enterprise system including twelve member server groups and a single administrative server group.

FIG. 8 is another diagram of one example of an enterprise system including a plurality of member server groups, a single administrative server groups, and several components and systems that may enhance system function.

FIG. 9 is a schematic representation of a feedback mechanism according to which a user forwards a confirmation message to a message server associated with the enterprise system generally illustrated in FIGS. 3-8.

FIG. 10 is a schematic representation of a feedback mechanism according to which a user submits a confirmation message to a web server associated with the enterprise system generally illustrated in FIGS. 3-8.

FIG. 11 is a schematic representation of a feedback mechanism according to which a web site proprietor sends a confirmation message both to a user and to a message server associated with the enterprise system generally illustrated in FIGS. 3-8.

FIG. 12 is a schematic representation of a feedback mechanism according to which a web site proprietor sends a confirmation message to a confirmation e-mail account associated with the enterprise system generally illustrated in FIGS. 3-8, and the enterprise system subsequently forwards the confirmation message to a user's personal e-mail account.

FIG. 13 is a schematic representation of a feedback mechanism according to which a web site proprietor sends a confirmation message to a user's e-mail account associated with the enterprise system generally illustrated in FIGS. 3-8.

FIG. 14 is a schematic representation of a feedback mechanism according to which a web site proprietor sends a text message including confirmation to a user's mobile device and the user forwards the text message to the enterprise system generally illustrated in FIGS. 3-8.

FIG. 15 is a schematic representation of a message server associated with the enterprise system generally illustrated in FIGS. 3-8 which collects sample confirmation messages from the participating web site proprietors and stores these samples in a database.

FIG. 16 illustrates an example web page through which a user may submit a copy of a confirmation message to the enterprise system generally illustrated in FIGS. 3-8.

FIG. 17 is a flowchart illustrating one example of a routine processing a confirmation message.

FIG. 18 illustrates an example web page through which an operator may handle confirmation messages flagged by an enterprise system generally illustrated in FIGS. 3-8.

FIG. 19 is a flowchart illustrating one example of a routine checking the content of a confirmation message.

FIG. 20 is a flowchart illustrating one example of a routine verifying encryption of a confirmation message.

### SUMMARY

In at least one embodiment, a method of reliably crediting a user for interacting with a participating business entity in a predefined manner includes receiving a copy of an electronic message to the user, verifying the integrity of the electronic message, identifying an award rule based on the information included in the message, and conditionally crediting the user based on the award rule and on the information contained in the electronic message. In some aspects, the method may utilize the available messaging between a business entity and the user. In this regard, the method requires relatively little cooperation from the business entities and users to reliably credit users for participating in one or more specified activities. In other aspects, the method retrieves award information from a variety of text, image, and other human-readable formats, thus eliminating the need to define additional communication schemes.

In at least one embodiment, the method may be implemented by an enterprise system such as an information gathering system, for example. In some embodiments, the user may be a registered participant, such as a member of a program provided by the enterprise system, or an unregistered user using the system on a one-time or a trial basis. In some contemplated embodiments, the participating business entity may be a web site proprietor such as a commercial provider of a product or service or a non-commercial solicitor of information or research data, and the enterprise system may allocate award points to the registered user's account for visiting the participating web sites, making purchases from these sites, responding to questionnaires, and otherwise interacting with the participating web sites in accordance with one or more business rules.

In some embodiments, the electronic message may be an e-mail message. In at least one such embodiment, the registered user forwards a confirmation e-mail message he or she has received from a participating web site to the enterprise system. The registered user may forward the message manually or automatically by means of an e-mail client, for example. In another such embodiment, the user submits the text and/or images included in the received confirmation e-mail message to the enterprise system via a web form. In yet another such embodiment, the participating web site directly sends the confirmation message both to the user and to the enterprise system. In another such embodiment, the enterprise system provides the registered user with an e-mail account within the domain of the enterprise system. The participating web site sends the confirmation e-mail to this account and the enterprise system automatically processes the e-mail upon arrival. Optionally, the enterprise system forwards the confirmation e-mail to another e-mail account, such as the registered user's preferred e-mail account (e.g., at yahoo.com or google.com).

In some embodiments, the method includes verifying the integrity of the electronic message by comparing the content of the electronic message to a sample previously collected from the corresponding web site proprietor. In one such embodiment, the method includes analyzing the format of the message by testing the message for the presence and positioning of certain words, images, or numbers. In some embodiments, the method includes checking the sequence numbers of transactions or order identifiers to ascertain the probability of the message being authentic. Alternatively or additionally, the method includes identifying other patterns such as the user's purchasing trends, pricing of a particular product or service by similar web site proprietors, or trends manifested by a particular web site proprietor.

In other embodiments, the method involves verifying the integrity of the electronic message by utilizing the methodologies of public key cryptography. In accordance with these embodiments, the web site proprietor digitally signs the confirmation message to prevent tampering with the contents of the message. In at least one contemplated embodiment, the web site proprietor signs each message using a private key and publishes the corresponding public key, i.e., makes the public key available to the registered user and to the enterprise system. In other embodiments, the web site proprietor uses one of the commercially available e-mail signing methodologies, such as DomainKeys Identified Mail (DKIM), for example.

In other embodiments, the method includes checking the electronic message for duplication to prevent fraudulent or erroneous multiple submission of the same confirmation to the enterprise system. In accordance with these embodiments, the method includes analyzing the transaction or order identity included in the electronic message, the name of the merchant or other type of web site proprietor, the purchase amount or other measurement of the user's participation included in the message, and other data. In one contemplated embodiment, the method additionally includes sending a confirmation message to the registered user to notify him or her that the electronic message has been processed and that his or her award account has been updated. On the other hand, a negative confirmation message may indicate to the user that the electronic message has been flagged and that the expected award has not been allocated.

### DETAILED DESCRIPTION

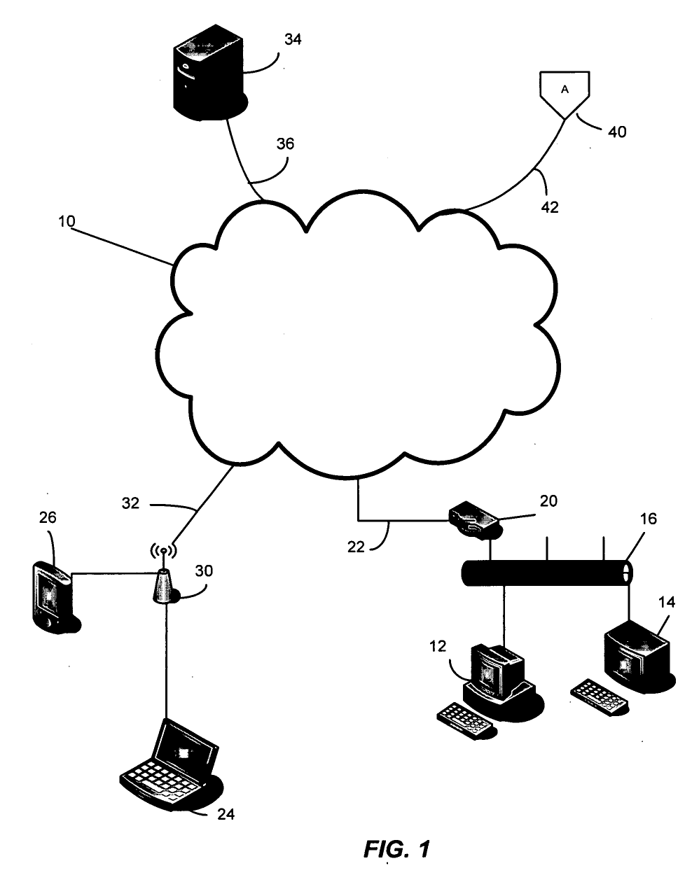

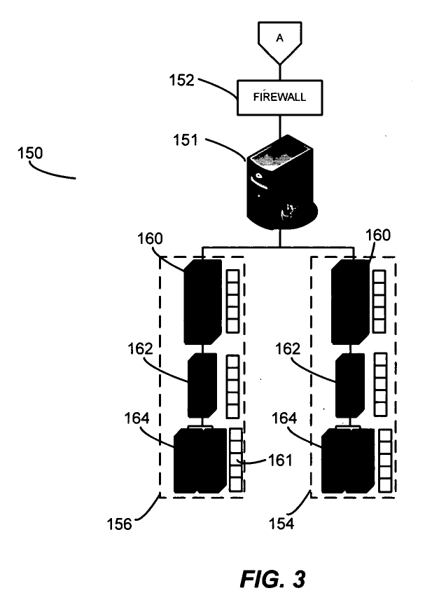

FIG. 1 illustrates an example of a network typical of the World Wide Web. A network 10 may be a virtual private network (VPN), or any other network that allows one or more computers, communication devices, databases, etc., to be communicatively connected to each other. The network 10 may be connected to a PC 12 and a computer terminal 14 via an Ethernet 16 and a router 20, and a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an enterprise system 40 for awarding points to registered users in exchange for demographic information, as generally illustrated in FIGS. 3, 5, 7, and 8 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

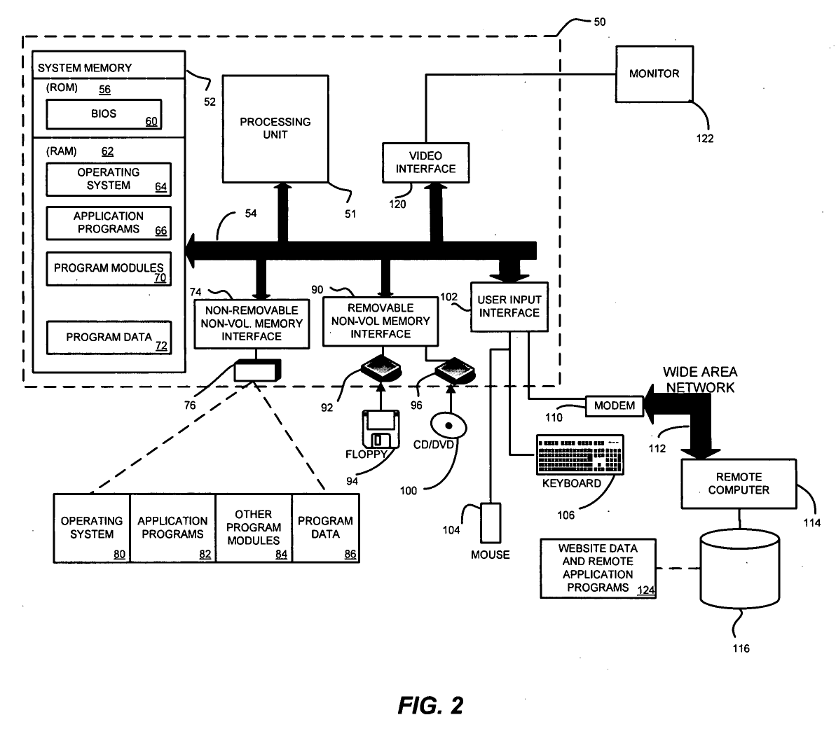

FIG. 2 illustrates a typical computing device 50 that may be connected to the network 10 of FIG. 1 and participate in a distributed computing environment such as the World Wide Web. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the blocks of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The computer 50 may include an assortment of computer-readable media. Computer-readable media may be any media that may be accessed by the computer 50. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, non-volatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 114 may be used.

As previously described, the system may award users with redeemable points for many reasons, such as, in exchange for collecting and releasing user demographic information to proprietors or clients and for users taking any action associated with a “campaign,” or set of rules negotiated by the proprietor. As used herein, a user or member may be any person, apparatus, method, or the like that employs a computing device 50 to access the system to earn redeemable points by completing proprietor-defined tasks in exchange for submitting and releasing demographic information to the system.

Further, as used herein, “demographic information” may be broadly construed and may include any kind of member descriptive data, any activity associated with a member, or any transaction associated with a member. Demographic information may be gathered by the system upon user registration in the form of a questionnaire designed to solicit various demographics data of interest to the proprietors. The questionnaire may be in the form of a website page or any other format able to collect demographics information from the user. Users may register in a variety of ways including direct registration at the central web site hosted by the enterprise system, registration through web site proprietors, a web based “refer-a-friend” program, third-party direct mailing, or other partner relationships. A user may need only to register with the system once. However, the user may earn additional points by completing future, supplementary questionnaires. Typical examples of information gathered by the questionnaires may be the user's age, income, occupation, etc. Further, the system may award a user for specific actions such as viewing web-based content, purchasing goods or services through a system-sponsored website, a proprietor's website, a proprietor's brick-and-mortar facility, or any other action associated with the system. The demographics information, to include but not limited to information gathered by questionnaire or records of any user action taken at the suggestion of or related to the system and a proprietor campaign, may be aggregated into a unique user profile. Once the user creates a profile, all future user activity within the system may be uniquely associated with the user's profile. A user may participate in the system by using a network 10 and a PC 12.

Further, as used herein, a proprietor or client may be any entity, corporation, web site manager, business owner, or the like that coordinates with the system by submitting a set of proprietor-defined award rules or tasks that a user may complete to earn redeemable points. The proprietor may also purchase user demographic information from the system and provide product price reductions or other benefits to users in exchange for user demographic information, or may complete any combination of these functions. This set of proprietor-defined rules or tasks may be called a “campaign.” Each campaign may further include a template for e-mails to be sent by the system to targeted users. A proprietor may compensate the system for receiving the users' demographic information in a number of ways including: monthly sponsorship fees for the system displaying their offers on the central web site; per action fees when users follow specific actions provided to the system; per click fees for users clicking on hyperlinks provided in targeted e-mails advertising proprietor services or products and directing the user to a proprietor Web page; per e-mail delivery fees; advertisement placement within “newsletter” e-mails that the system may send to all system-registered users; and other fee combinations including indirect, agency relationships between proprietors and the system. Also, the system may compensate a proprietor for soliciting new memberships. The system may further automate billing clients based on a set billing rules within each campaign. The billing rules may be associated with award rules and user activity. For example, within a particular campaign, an award campaign rule may award a member two hundred points for making a single purchase with a proprietor. The campaign may also include a billing rule indicating that the proprietor may be billed at five percent of all purchases made by the member, even though only the first transaction awarded points. Also, a proprietor may customize its campaign to award a user points in a variety of methods. For example, a proprietor may choose the number of points to be awarded to users, may specify activities or questions that must be completed by the user before points are awarded, or may limit the frequency at which users can be awarded points for visiting the site. A proprietor may also dictate different user questionnaires during the registration process or may provide an additional questionnaire as a user task to be completed by the user to earn additional points.

Also, as used herein, the system may refer generally to the method or apparatus that coordinates user and proprietor functions by collecting user demographic information, awarding redeemable points to the users, tracking points for the users or proprietors, aggregating statistical information concerning user activity and the demographic information, maintaining the proper function of all user and proprietor activity, providing statistical and demographic information to the proprietors, sending targeted e-mail to the users, and executing any other management or coordination functions. The targeted e-mails may contain hyperlinks that direct users to proprietor offers that may award or redeem points to a specific user account. The system may be a collection of devices, typically general purpose computing devices 50, servers, 34, and data stores connected to and in communication with a user PC 12 through a network 10.

A system for collecting demographics information in exchange for awarding redeemable points may include a variety of structures and components as generally described in relation to FIGS. 3, 5, 7, and 8. Therefore, the system configurations described in relation to FIGS. 3, 5, 7, and 8 may include any combination of elements described in relation to each figure.

With reference to FIG. 3, the system 150 may include an architecture that is N-tier with a web server 151 in communication with a system firewall 152 through which a user may access a website hosted on the web server 151 by the system 150. The system firewall 152 may provide a secure, high-speed connection to a computer network such as the Internet as illustrated in FIG. 1. The web server 151 may face the users and communicate with a number of server groups or “silos” such as silo 154 and silo 156. A silo may be a conceptual collection of servers that work together through an application interface. Each silo may include, for example, an application server 160 that may execute a system application program 161.

With reference to FIG. 2 and FIG. 3, a system application program 161 running on the application server 160 may be an application program 66 or a remote application program 124 and may perform any coordination, transformation, or update process on the data entering or exiting a master data server 162. Further, a system application program 161 may execute on any general computing device 50 or any system 150 component. A system application program 161 running on the application server 160 may include, for example, any combination of an e-mail engine, a query engine, a validation engine, a crypto engine, an award engine, or a transaction engine.

Returning to FIG. 3, the application server 160 may communicate between the web server 151 and a master data server 162 to pass data from the web server 151 or to pass data generated by the system application programs 161 to the master data server 162 or any other system 150 element. The master data server 162 may include a portion of the total system 150 data, consisting of, for example, user demographic data, campaign data, and any other data used by the system 150. In turn, the master data server 162 may communicate with replication data servers 164. The replication data servers 164 may include a duplicate copy of the user profile data assigned to the silos 154, 156.

The system capacity is expanded simply by adding more silos 154, 156. The silos 154, 156 may also provide specialized functions within the system 300. For example, the silo 156 may be an administrative silo 156. The administrative silo 156 may be used by the system 150 to manage system information, campaign information, or any other information not related to the user profiles. The administrative silo 156 may also include a lookup table that may direct any data queries to the correct member silo 154. The administrative silo 156 may combine several different functions together, or it may be split apart into separate silos. For example, one administrative silo may contain campaign information while a separate administrative silo may contain a lookup table to direct any data queries to the correct member silo 154. Alternatively, there could be a third administrative silo which manages, for example, inventory information for redemptions. Thus, the administrative functions need not be confined to a single administrative silo. It should be noted that separating some functions into multiple administrative silos may increase the scalability of the system as a whole.

The member silo may hold the system 150 member information. The member information may include, for example, the user profile, demographics data, transactions, or point balances. As illustrated in FIG. 3, a system comprising one member silo 154 may hold approximately 100% of the total system 150 user information. Upon registration, a member's information may be stored in the member silo 154. The silo containing the member's registration data may be called the member's “home silo.” Each member 's information may be kept in the member's “home silo.” However, when more member silos are added to the system 150, the member's information may be moved to one of the new silos, if desired.

As an overview, members are assigned a large variety of attributes, which may be stored in each member's profile contained within a member silo 154 as member attributes. Member attributes may include a wide variety of information about the member, including, but not limited to, demographic information, member activity information, information derived from other member attributes, etc. For example, an external process may monitor past activity of a member and update the information in the corresponding member attribute. Member attributes may be described as a question and a response, where a member's choice of one or more answers to the question is stored as the response and indicates the presence or absence of a particular response in the member profile. In some instances, a member may not provide a response, in which case the question of the member attribute does not include a response. Initially, the same questions may be provided to all of the members, however, the answers to the questions may prompt subsequent questions that are not the same for all the members. For example, a member who provides a response of “male” in response to the question “gender” may be prompted with subsequent questions directed to a male demographic, whereas a member who provides a response of “female” to the question “gender” may be prompted with subsequent questions directed to a female demographic. In addition, the questions may include multiple answers. For example, a member may be prompted to provide information about sporting activities that interest the member with the question “sports,” and the member may choose a single answer such as “football” as a response, choose multiple answers such as “football,” “baseball” and “basketball” as a response or set of responses or choose no answer at all.

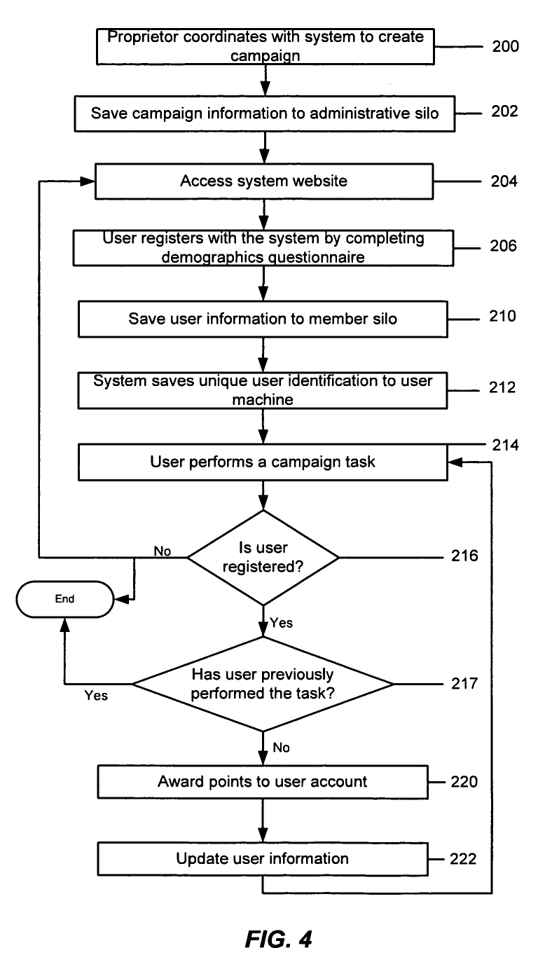

With reference to FIG. 1, FIG. 3, and FIG. 4, a method employing the enterprise system 300 may provide a user with a number of redeemable points for the user's submission of demographic information and participation in a variety of ecommerce related activities, including making purchases from proprietors. The user may then redeem their points for products and services from the participating proprietors such as retailers, theaters, restaurants, airlines, and hotels, among others. At block 200, a proprietor may coordinate with the system 150 to create a campaign. For example, the proprietor may request information from the system 150 to target a specific demographic variable such as age, gender, income, or job. At block 202, the campaign information may be distributed to the silos 154, 156 and distributed across all system master data servers 162. At block 204, a user may login to the system 150 using a general purpose personal computer (PC) 12 connected to a network 10 such as the Internet.

As previously described, at block 206, the user may register with the system 150 by accessing a web site hosted by the system 150 at the web server 151. During registration, the user may complete a demographics questionnaire in the form of a web site or other electronic document. The demographics questionnaire may include various questions concerning the user's background including, for example, the user's age, sex, zip code, job title, or marital status. The system, 150 may collect the demographics data in a variety of formats including free form text, drop down menu selections, or Boolean values.

At block 210, the user's registration information and demographic data may be saved to a member silo 154. At block 212, the system may save a unique user identification to the users PC 105. The unique user identification may be used by the system to associate proprietor campaign tasks and user actions to award points. The unique user identification may be encrypted in the form of a “cookie” associated with the user's browser that may be used to associate the user with the registration information stored on the administrative silo 156. Further, the system may assign a 64-bit random number to each user upon registration. Because of the extremely low statistical probability of assigning identical 64-bit random numbers to more than one member upon registration, the system 150 need not verify that the random number has been previously assigned. The random user identification assignment may allow the system 150 to more easily select random user demographic information for analysis. Particularly, because the numbers are randomly assigned, any set of records associated with a sequential selection of the random user identifier may be very unlikely to overlap with any other set chosen by the random number. Because the probability of the system 150 assigning identical 64-bit random numbers is very small, and a few identical numbers will have very little effect on statistical analysis, it may be unnecessary to ensure that a random number has not been previously assigned.

At block 214, the user may perform any of the tasks or actions specified in the proprietor's campaign stored on the administrative silo 156 to earn redeemable points. For example, a campaign task may be visiting the proprietor's web site or responding to a system 150 generated e-mail.

Each proprietor web site may include a visual cue that the web site is a member of the points-awarding program. The visual cue may include a hyperlink pointing to the web server 151. The hyperlink may include a code called an “cell identification” that may optionally be encrypted and may associate the user's selection of the hyperlink with a campaign task saved on the administrative silo 156. Further, the cell identification may provide information associated with all campaign rules. A user may also receive and select hyperlinks associated with a proprietor's campaign in an e-mail message generated by an e-mail engine running as a system application program 161 on the replication server 164.

The e-mail engine could alternatively be run on the application server 160. However, to increase efficiency, the e-mail engine is run on one or more of the replication servers 164 on each member silo 154. In this way, the e-mail engine communicates locally with the database, avoiding network traffic and also avoiding additional load on the application server 160 which is servicing member requests in real-time. This is possible because the e-mail engine is able to work with a replicated copy of the member information. This provides for a great deal of scalability, as additional replication servers 164 could be added. For example, the replication servers 164 could be increased from two to four so that more than one e-mail engine is running for a given member silo 154.

At block 214, the administrative silo 156 and the application server 160 may validate the user's registration with the award program by comparing the user's cookie file with the registration information stored on the administrative silo 156. The validation process may be performed by a validation engine running as a system application program 161 on the application server 160. If the information received by the application server 315 is encrypted, a crypto engine running as a system application program 161 on the application server 160 may decrypt the information. If the user is not registered, at block 216, the process may terminate or, alternatively, the user may be directed to the system registration web site at block 204. If the user is validly registered, the system 150 may proceed to block 217.

At block 217, the validation engine may determine if the user has previously completed the campaign task associated with block 214. As described above, awarding points may be conditional and defined by the proprietor campaign rules. The campaign tasks and rules may be defined by the proprietor and stored on the administrative silo 156 or distributed across all system 150 silos 154, 156. The tasks and rules may be indexed on the administrative silo 156 by the cell identification. Using the cell identification, the validation engine may determine that a particular cell identification has been previously used, also indicating that the user has previously performed the task and that the user is ineligible for additional points. If the user has previously performed the task, the system 150 may terminate or direct the user to perform a different task. If the user has not yet performed the task, the system may proceed to block 220.

At block 220, if the user is validly registered and has not yet performed the present campaign task, a transaction engine running as a system application program 161 on the application server 160 may award a predetermined number of points to the user's account saved on the member's home silo 154 by associating the campaign task, cell identification, and point quantity with the unique user identification. It should be noted that this block is optional, as are many of the blocks in FIG. 4. The system could be configured to award points or perform actions in numerous alternative ways, such as, for example, once, daily, unlimited, other, etc. In other words, the system may be configured to keep track of whether a user has performed a required task before, and whether additional performances of the task could earn additional points. It is also noted that the system might do things other than award points, such as, for example, directly awarding something else of value, such as a gift card, updating a member's profile information, sending a message to the member, sending a message to a client about the member, changing the member's account status, or numerous other things. One of ordinary skill in the art will readily appreciate that there are various ways of paginating data and the system could be configured to do any of them.

At block 222, the transaction engine running as a system application program 161 on the application server 160 may update transaction information associated with the user at the member's home silo 154. Transaction information may later be used by the system 150 to develop demographic information and statistics associated with the user actions to provide to the proprietors. Therefore, upon visiting the proprietor site, the system 150 may automatically award points to the registered user without requiring the user to leave the proprietor web site. The system 150 may be distributed across multiple participating web sites and may operate without the knowledge of the user. Optionally, the proprietor's web sites may determine whether a web site visitor is one of the participating users.

The system 150 may also provide hyperlinks to redemption sites at which the users may convert earned points into products or services. The hyperlinks may be embedded in e-mails generated by the e-mail engine system application program 161. Further, the hyperlinks may point to redemption web sites hosted by the system 150 or on hosts at any other proprietor-designated site. The system 150 may automatically accept redemption orders, place purchase orders with vendors for the requested product or service, and may direct the proprietor or vendor to deliver the redeemed products to the user. The points may be automatically deducted from the user's account.

The system 150 may also develop demographic information and statistics to provide for the proprietors. The system 150 may associate the user demographic information with the user's actions associated with the proprietor or any other web site. For example, the percentage of the males visiting a particular web site or web pages may be calculated by looking at each participating visitor in the member silo 154, checking a field in the member silo 154 for each member's sex, and tabulating the results.

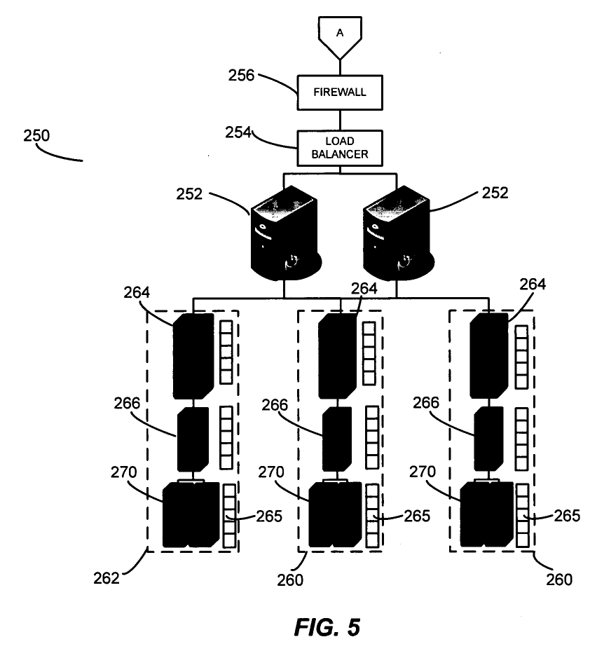

With reference to FIG. 5, the system 250 may include a distributed architecture that is N-tier with web servers 252 that may communicate with a load balancer element 254, wherein the load balancer element 254 communicates with a system firewall 256 and the web servers 252. The load balancer 254 may randomly distribute all data entering the system 250 through the firewall 256 across the web servers 252. The web servers 252 may then determine a silo 260, 262 to send the data. Thus, upon the receipt of data, the load balancer 254 may select a random web server 252, and the randomly-selected web server 252 may forward the data to a specific silo 260, 262, or to a randomly-selected silo 260, 262. The randomly-selected silo 260, 262 may then determine whether to process the data or forward the data to another silo 260, 262. The load balancer's 254 random distribution of data may reduce data latency through the system 250. The load balancer element 254 may include a method executing on a general purpose computer 50 or on any device associated with the system 250 as either software or hardware.

The system firewall 256 may provide a secure, high-speed connection to a computer network such as the Internet as illustrated in FIG. 1. The web server 252 may face the users and communicate with a number of silos 260, 262. A silo may be a conceptual collection of servers that work together through an application interface. Each silo may include, for example, an application server 264 that may execute a system application program 265. A system application program 265 running on the application server 264 may perform any coordination, transformation, or update process on the data entering or exiting the master data server 266. Further, a system application program 265 may execute on any general computing device 50 in communication with the master data server 266. A system application program 161 running on the application server 160 may include, for example, any combination of an e-mail engine, a query engine, a validation engine, a crypto engine, an award engine, or a transaction engine. Each silo may include an application server 264, wherein the application server 264 may communicate between the web server 252 and a master data server 266, and the master data server 266 may communicate with replication data servers 270. The replication data servers 270 may include a duplicate copy of the user profile data assigned to a silo 260, 262.

The silos 260, 262 may provide simple system expandability by providing more silos 260, 262 to the system. The silos 260, 262 may also provide specialized functions within the system 250. For example, the silos 260, 262 may include an administrative silo 262 and member silos 260. The administrative silo 262 may be used by the system 250 to manage system information, campaign information, or any other information that may not relate to the user profiles. The administrative silo 262 may also include a lookup table that may direct any data queries to the correct member silo 260. The member silos 260 may hold an equal or approximately equal fraction of the total amount of user information contained in the system 250 as determined by the load balancer 254. As illustrated in FIG. 5, a system comprising two member silos may each hold approximately 50% of the total system 250 user information. Upon registration, a user's information may be stored on a single, randomly selected member silo 260. The silo containing the user's registration data may be called the user's “home silo.” Each user's information may be kept in the user's “home silo,” and may remain in the home silo unless the member silos 260 are rebalanced. By randomly assigning profiles to the silos, the system load may be balanced and the number of user profiles saved to a single member silo 260 may be no more than any other individual silo 260.

With reference to FIG. 24, one function of the administrative silo 262 may be to perform distributed queries to the member silos 260. In particular, queries initiated from the administrative silo 262 may give the appearance of a single data repository, despite being distributed across multiple member silos 260. Furthermore, the distributed architecture may allow the system 250 to distribute the query across multiple system elements to minimize system processing latency. For example, at block 890, an administrative silo 262 may initiate a query for a particular set of member data from the member silos 260.

The system 250 may contain a very large number of entries that satisfy the query, but a system variable may limit the displayable number of entries to a subset of the total satisfying entries. For example, a particular query may return a total of two hundred entries, but the system 250 may only display a set of ten to the user at one time. Because the number of displayable entries is limited, at block 892, the system need only perform a “mini-query” at each member silo 260 to request only a number of satisfying entries equal to the maximum number of displayable entries. For example, if the system 250 contains two member silos 260, and the maximum number of entries the system 250 may display at one time equals ten, then the system 250 may only ask for ten satisfying entries from each silo 260. And, if there are at least ten satisfying entries on each silo 260, at block 894, the system 250 may return a total of twenty entries to the administrative silo 262 to display the first ten entries. The system 250 may also be utilized to obtain counts of the total number of records matched, regardless of pagination.

At block 896, the system 250 may then record meta data about the satisfying entries. For example, the system 250 may record the number of entries returned by each silo 260 as well as the last member identification number at which the query was satisfied at each particular silo 260. The meta data may allow the system 250 to locate a particular query's satisfying entries without saving the actual entries. At block 900, the administrative silo 262 may then join and sort the entries according to the criteria selected by the administrative user or by other criteria. One example of a process by which the data may be joined and sorted is a merge sort algorithm. At block 902, the system 250 may store the entries it cannot display due to the viewable limit. Thus, at block 904, the administrative user may be able to view up to full page of sorted data that satisfies the request.

At block 906, if the mini-queries to the member silos 260 returned more than the maximum number of viewable, at block 910, the user may display another page of satisfying entries to include the remaining entries stored at block 902. If there are no more satisfying entries in the cache and, at block 912, all system 250 entries have been checked against the query, the method may terminate. If, at block 912, more system entries remain to be checked against the query, the method may perform another set of mini-queries. Once the administrative user displays the remaining entries at block 910, the system may perform another mini-query at each silo 260 until all system 250 records are searched. For each subsequent mini-query to a member silo 260, the system 250 may request less than the maximum number of viewable entries. For example, if the maximum number of viewable entries is ten, and the number of satisfying entries originating from a particular silo 260 and currently stored at the administrative silo 262 is three, a subsequent mini-query to that particular silo 260 may be configured to request a maximum of seven satisfying entries. The system 250 may then join and sort all entries at the administrative silo 262 as before. Therefore, the total number of entries at the administrative silo 262 from any particular member silo 260 may be no more than the maximum number of displayable satisfying entries. Requesting only the fewest number of needed satisfying entries ensures the lowest possible strain on the system 250 during the query process.

To ensure that the system 250 returns unique satisfying entries with each subsequent mini-query, the system 250 may, at block 914, modify the entry meta data stored at block 896 to find a next satisfying entry at a home silo. For example, the system 250 may increment the last member identification number at which the query was satisfied at a particular silo 260 and begin the next mini-query at the record matching the incremented entry. Because each query is made up of a number of mini-queries based on the maximum viewable number of records, the system 250 may ensure that the administrative user sees only the most accurate, up-to-date member information.

Further, the administrative silo 262 need not store every record of a query in order for the administrative user to move freely backwards from the last satisfying entry to the first. Specifically, for each page of satisfying entries viewed, the administrative silo 262 may only need to store enough information to locate the records of the previous page and not the complete records. For example, by storing only the first member identification number and the corresponding member silo 260 number of the previously displayed satisfying records, the system 250 may build the previously displayed listing. The system 250 may then perform another series of mini-queries to fill in the remaining records to display a complete, previously-viewed listing.

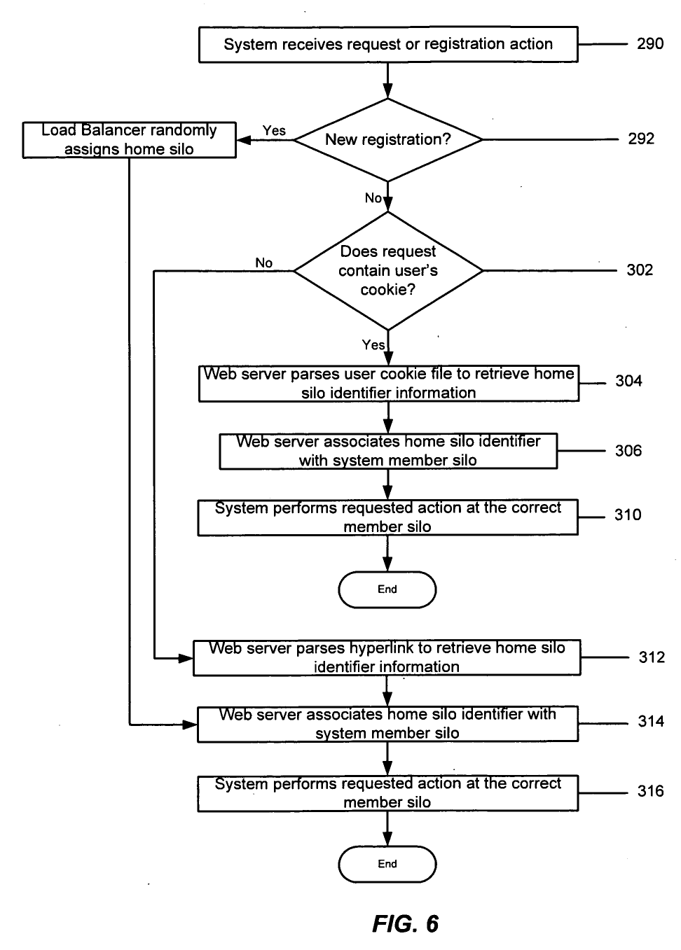

With reference to FIG. 5 and FIG. 6, and as previously described in relation to FIG. 4, the system 250 may need to periodically retrieve or update member silo 260 data to the user's home silo. To correctly identify the user's home silo upon a retrieve or update action, the user's home silo identifier may be persistently stored in several different forms. Particularly, the home silo identifier may be part of a hyperlink in a bulk e-mail sent from the system 250 to the user. Further, the home silo identifier may be part of a URL stored at the user's computer, or may be part of a cookie file. The persistent storage of the user's home silo identifier on the user's computer may also reduce any system 250 overhead associated with finding the user's information. However, once the user is at the system 250, the home silo identifier is not needed to view any successive pages during a single session; the system only requires the home silo identifier upon the first action a user takes at the system 250 during the session. Therefore, the system 250 may acquire user's unique identification number and home silo identifier through encrypted information embedded in a hyperlink included in an e-mail or from any other source. By using the encrypted information, the user may not need to login to the system 250 to complete a transaction. A user may only need to explicitly login to the system 250 when the user visits the central website without going through a hyperlink containing the encrypted identification information and the user's browser does not contain an identifying cookie, or, when the user may perform a “sensitive” action associated with a user's private information or a transaction that may decrease the user's accumulated points.

The system 250 may identify not only the user's home silo but also cached user information through the use of an “application server session.” During an application server 264 session, the system 250 may automatically store a cookie on the user's browser. The cookie may then be used to locate any cached information (including the user's home silo identifier) on successive page views. During an application server session, the cookie may be referred to as a “session cookie.” Thus, while the user is actively at the system 250 and keeping his session with the system 250 open (i.e. does not end the session by closing the browser, deleting all browser cookies, or otherwise ending his session), the system 250 may not need to actively find the user's home silo identification. The system 250 may automatically forward requests to a user's home silo based on the user's application server 264 session. The system may automatically forward the requests using an Apache™ web server 252 with ModJK extensions to a Jetty™ Java™ servlet engine application server 264.

At block 290, the system 250 may receive a user login request, registration request, or update action. If, at block 292, the system 250 receives a new registration, the load balancer 254 may forward the data to a random web server 252 and the web server 252 may assign the registration information a random home silo identifier. By randomly assigning all registrants a home silo identifier, each member silo may contain an approximately equal amount of member information. Further, the data need not retain its home silo identification for its lifetime and may be distributed to other silos 260, 262 as needed for redistribution because no particular data characteristic may tie the data to a silo 260, 262.

After storing the new member information, the system 250 may proceed to block 314. The user request or update action may come from a hyperlink embedded in a targeted e-mail generated by the e-mail engine executing as a system application program 265 on the application server 264. The hyperlink may include the user's home silo identifier information, or alternatively, the action may originate from the user's browser and include the user's cookie file.

If, at block 292, the system 250 receives a non-registration request, the system may, at block 302, determine if the request contains the user's cookie file. At block 304, if the request contains the user's cookie file, the web server 252 may parse the user's cookie file to retrieve the user's home silo identifier information. At block 306, the web server 252 may associate the home silo identifier with a particular system 250 member silo 260. At block 310, the system 250 may perform the requested action at the user's home silo 260. Therefore, the system 250 may perform the action with the user's home silo 260 without performing a lookup or redirect action when the action includes the user's cookie file.

If, at block 302, the request does not contain the user's cookie file, the request likely originated from a system-generated hyperlink that was targeted to a particular user, or the user's browser may not contain the cookie file that correctly associates the user with the user's home silo. The hyperlink therefore may contain the user's home silo identifier 260. At block 312, the web server 252 may then parse the hyperlink to retrieve the user's home silo identifier information. At block 314, the web server may associate the home silo identifier with the correct member silo 260. Therefore, the system 250 may perform the action with the user's home silo 260 without performing a lookup or redirect action when the action originates from a hyperlink containing the user's home silo identifier.

Further, the user's cookie file may contain an inaccurate home silo identifier due to data redistribution or any other reason that may result in the user's data being moved to a location other than a location indicated by the cookie file. If the inaccurate information leads the action to an incorrect silo, the receiving member silo 260 may treat the action as if no browser cookie existed and perform a lookup action to re-direct the data to the correct silo and save a new, accurate, cookie file to the user's browser. Therefore, the system 250 may perform the action with the user's home silo 260 by performing a lookup or redirect action when the action includes an inaccurate cookie file.

Further, if the user's cookie is not set, the system may perform a lookup action by accessing the lookup table residing on the administrative silo 262. Also, if the member's cookie is not set or not present, the load balancer 254 may direct the user to a random member silo 260. A system application program 265 running on the application server 264 may query the master data server 266 or the replication data servers 270 to determine if the action relates to member information stored at that silo 260. If the member data is not stored on the silo 260, the application server 264 may broadcast a request to all silos 260, 262 to find the user's home silo. Once the user's home silo 260 is found, the system 250 generates a re-direct message to the user's browser to re-establish a connection to the system 250 through the web server 252 at the proper home silo 260. The user's browser may then re-establish a connection to the system 250 with a connection message containing the correct home silo 260 identifier. Once the web server 252 receives the re-connect request, user is directed to the proper home silo 260, and the transaction may continue. At block 316, the system 250 may perform the requested action at the correct member silo 260.

As may be appreciated by one of ordinary skill in the art, the system's silo architecture is scalable and inexpensive. Further, the system is robust in that a single silo's malfunction will not degrade the function of the entire system.

With reference to FIG. 7, the system 350 may also include a distributed architecture that is N-tier with six web servers 352 that may communicate with two load balancer elements 354, wherein the load balancer elements 354 communicate with a system firewall 356 and the web servers 352. The load balancer 354 may randomly distribute all data entering the system 350 through the firewall 356 across the web servers 352. The load balancer's 354 random distribution of data may reduce data latency through the system 350. The load balancer element 354 may include a method executing on a general purpose computer 50 or on any device associated with the system 350 as either software or hardware. The system firewall 356 may provide a secure, high-speed connection to a computer network such as the Internet as illustrated in FIG. 1. The web servers 352 may face the users and communicate with a number of silos 360, 362. A silo may be a conceptual collection of servers that work together through an application interface. Each silo may include an application server 364 executing a system application program 365, wherein the application server 364 may communicate between the web servers 352 and a master data server 366, and the master data server 366 may communicate with replication data servers 370. The master data server 366 and the replication data servers 370 may contain the member profile data to include demographic information, member transaction information, and all member-related data. Member transaction information may include records of every activity in which the member participates including registration information, purchase and activity tracking information, and point-earning information. A system application program 365 running on the application server 364 may perform any coordination, transformation, or update process on the data entering or exiting the master data server 366. Further, a system application program 365 may execute on any general computing device 50 in communication with the master data server 366. A system application program 365 running on the application server 364 may include, for example, any combination of an e-mail engine, a query engine, a validation engine, a crypto engine, an award engine, or a transaction engine. The replication data servers 370 may include a duplicate copy of the user profile data assigned to a silo 360, 362.

The silos 360, 362 may provide simple system expandability by providing more silos 360, 362 to the system. As illustrated in FIG. 7, the system may be expanded to 13 silos 360, 362. The silos 360, 362 may also provide specialized functions within the system 350. For example, the silos 360, 362 may include an administrative silo 362 and twelve member silos 360. The administrative silo 362 may be used by the system 350 to manage system information, campaign information, or any other information that may not relate to the user profiles. The administrative silo 362 may also include a lookup table that may direct any data queries to the correct member silo 360. The member silos 360 may hold an equal or approximately equal fraction of the total amount of user information contained in the system 350 as determined by the load balancer 354 random assignment. As illustrated in FIG. 7, a system comprising twelve member silos may each hold approximately 8% of the total system 350 user information. Upon registration, a user's information may be randomly stored in one member silo 360. The silo containing the user's registration data may be called the user's “home silo.” Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360.

Further, the member silos 360 may have differing storage capacities. The random distribution of data stored on each member silo 360 may then be based on the percentage of system capacity represented by a particular member silo 360 by weighting the preference of the web server 352 to select a home silo 260 upon registration. Thus, a silo 360 having twice the capacity as another silo 360 may be given twice the weighting during random selection. Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360. Also, each silo 360 may poll the system 350 to determine its percentage of system capacity. Instead of random home silo selection, a closed-loop selection mechanism may, for new registrations or anonymous requests, prefer the silo 360 with the least-utilized capacity. Capacity may be measured by any suitable function and may take into account, for example, the amount of disk space available, the system processing load, the I/O capacity, the number of members, or other factors.

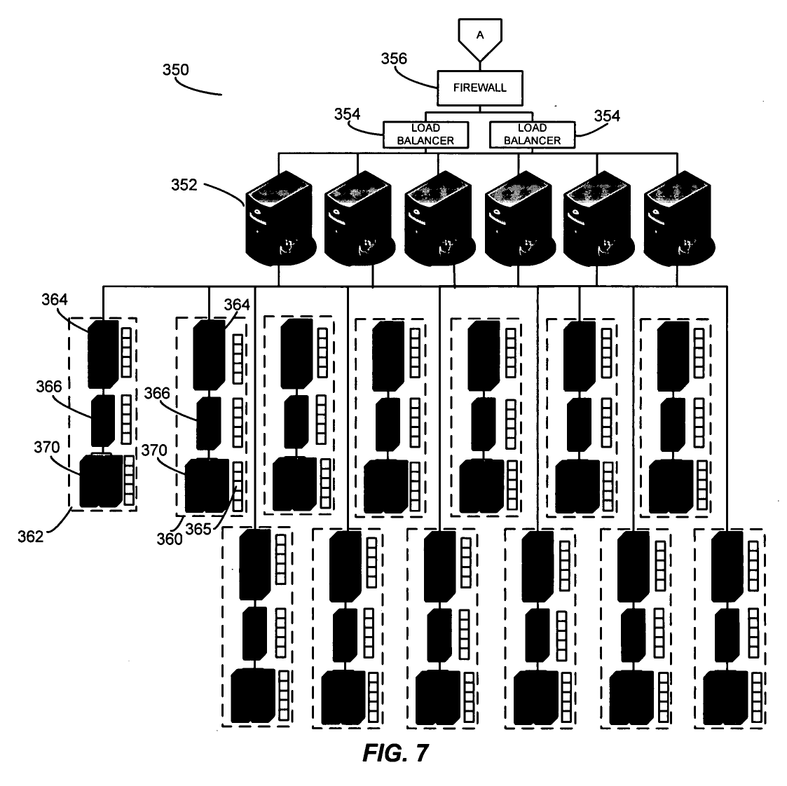

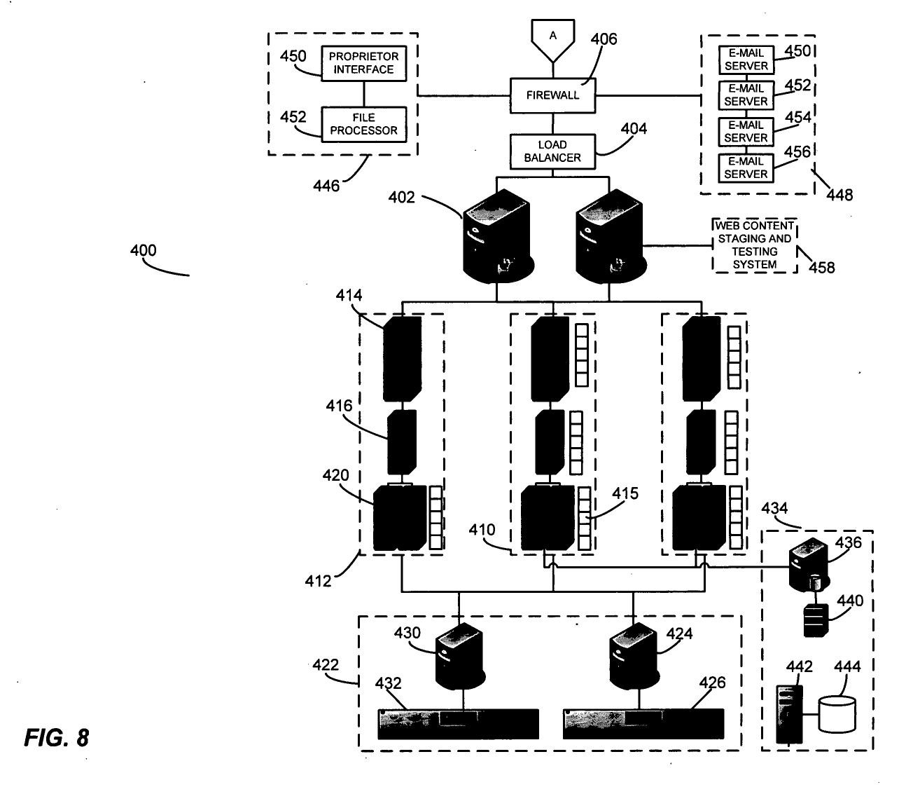

With reference to FIG. 8, the system 400 may also include several components that may complement the awarding of points as previously described. Further, the components may also be added to any of the systems 150, 250, 350 as previously described. As described above, the system 400 may include a distributed architecture that is N-tier with web servers 402 that may communicate with a load balancer element 404, wherein the load balancer element 404 communicates with a system firewall 406 and the web servers 402. The load balancer 404 may randomly distribute all data entering the system 400 through the firewall 406 across the web servers 402. The load balancer's 404 random distribution of data may reduce data latency through the system 400. The load balancer element 404 may include an application executing on a general purpose computer 50 or on any device associated with the system 400 as either software or hardware.

The system firewall 406 may provide a secure, high-speed connection to a computer network such as the Internet as illustrated in FIG. 1. The web server 402 may face the users and communicate with a number of silos 410, 412. A silo 410, 412 may be a conceptual collection of servers that work together through an application interface. Each silo 410, 412 may include an application server 414 executing a system application program 415, wherein the application server 414 may communicate between the web server 402 and a master data server 416, and the master data server 416 may communicate with replication data servers 420. A system application program 415 running on the application server 414 may perform any coordination, transformation, or update process on the data entering or exiting the master data server 416. Further, a system application program 415 may execute on any general computing device 50 in communication with the master data server 416. A system application program 415 running on the application server 414 may include, for example, any combination of an e-mail engine, a query engine, a validation engine, a crypto engine, an award engine, or a transaction engine. The replication data servers 420 may include a duplicate copy of the user profile data assigned to a silo 410, 412.

The silos 410, 412 may provide simple system expandability by providing more silos 410, 412 to the system. The silos 410, 412 may also provide specialized functions within the system 400. For example, the silos 410, 412 may include an administrative silo 412 and member silos 410. The administrative silo 412 may be used by the system 400 to manage system information, campaign information, or any other information that may not relate to the user profiles. The administrative silo 412 may also include a lookup table that may direct any data queries to the correct member silo 410. The member silos 410 may hold an equal or approximately equal fraction of the total amount of user information contained in the system 400 as determined by the load balancer 404. A system comprising two member silos may each hold approximately 50% of the total system 400 user information. Upon registration, a user's information may be randomly stored in one member silo 410. The silo containing the user's registration data may be called the user's “home silo.” Each user's information may be kept in the user's “home silo, ” and may remain in the home silo unless the member silos 410 may be rebalanced. By randomly assigning profiles to the silos 410, 412, the system load may be balanced and the number of user profiles saved to a single member silo 410 may be no more than any individual silo 410.

Further, the silos 410, 412 may collectively communicate with a backup system 422. The backup system 422 may store a duplicate copy of all data stored in the system silos 410, 412. The backup system 422 may include a very high memory capacity server including a primary backup server 424. An example of a very high memory capacity server 424 may be a 2 TB array server. The primary backup server 424 may communicate with a high capacity data cache 426. An example of a high capacity data cache may be a 21 slot, 2-drive LTO2 tape library such as the Exabyte® Ultrium™ family of LTO tape drives. The backup system 422 may further include a secondary backup server 430. The secondary backup server 430 may also be a 2 TB array server. The secondary backup server 430 may also communicate with a secondary high capacity data cache 432. An example of a secondary high capacity data cache may be an LTO3 tape drive such as the Quantum® LTO-3 drive.

Referring again to FIG. 8, the member silo 410 replication data servers 420 may collectively communicate with a data warehouse system 434. The replication data servers 420 may communicate with a database server 436. The database server 436 may include an extract/transform/load (ETL) server. The database server 436 may communicate with a data warehouse server 440. The data warehouse server 440 may include a 2 TB array. The data warehouse system 434 may also include legacy data related to prior versions of the points-awarding system 400. The legacy data may be stored in a modular workgroup server 442 such as the Sun Microsystems® E420R. The workgroup server 442 may further communicate with one or more data stores 444 containing the legacy data.

A proprietor interface system 446 may also communicate directly with the system 400 through the system firewall 406. The proprietor interface system 446 may allow a proprietor to directly access user data stored on the system silos 410, 412. This access may allow the proprietors to collect demographic and statistical information concerning the user data on the silos 410, 412. The proprietor interface system 446 may include a proprietor interface 450. The proprietor interface 450 may be a secure connection to allow the proprietors to upload or download data to the system 446. The proprietor interface 450 may employ a protocol enabling the secure transmission of web pages such as hypertext transfer protocol over a secure socket layer (https).

The proprietor interface 450 may be in communication with a file processing element 452. The file processing element 452 may allow proprietors to access the system 400 to shop for demographics information or to store and process client information or added demographics questions for use during user registration. Proprietors may also upload member activity which is stored as member transactions in the member's home silo and which may, further, trigger both billable activity transactions and award transactions in association with each particular member and each particular campaign.

An e-mail relay system 448 may also communicate with the system 400 though the firewall 406. The e-mail relay system 448 may include four servers 450, 452, 454, 456 in communication with the system 400. The e-mail relay system 448 may direct incoming e-mails, such as delayed bounces from outgoing bulk mails sent by the system, to the proper components of the system 400.

A web content staging and testing system 458 may also communicate with the system in a variety of methods. For example, the web content staging and testing system 458 may communicate with the system 400 through the web severs 402. The web content staging and testing system 458 may comprise a number of general computing devices 50 that may provide a secure and efficient environment for system 400 administrators to develop a variety of data for the system 400 before the data may be deployed live.

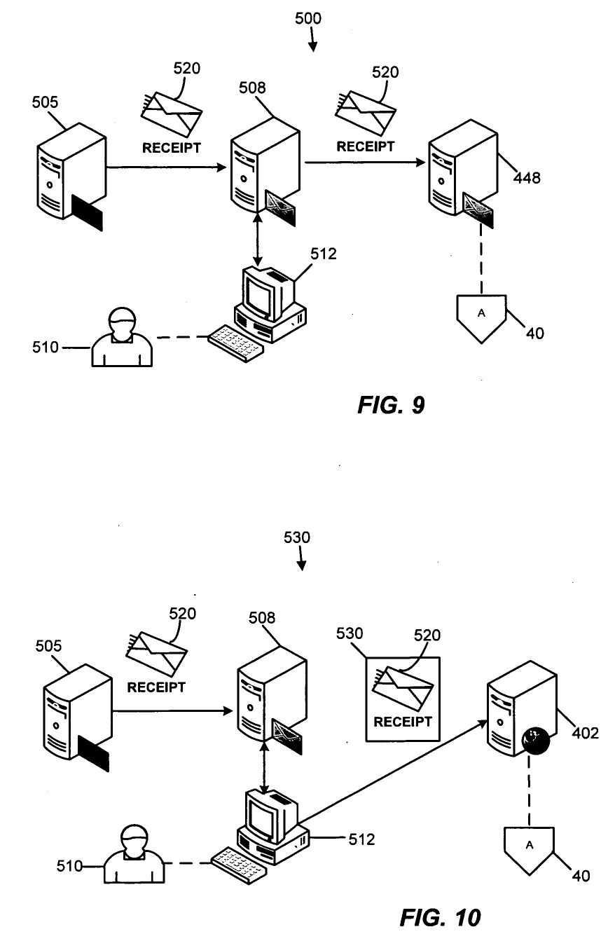

As indicated above, the enterprise system 40 may award users with redeemable points or other forms of credit for taking action associated with “campaigns,” or sets of rules negotiated by the participating web site proprietors. To this end, the system 40 may receive activity reports from the proprietors to allocate awards to the users according to the negotiated rules. However, the requirement to submit reports according to one or more predefined formats places a substantial technical and financial burden on the proprietors. Moreover, the proprietors may not always submit the reports on time, or may inadvertently enter wrong information, or otherwise misrepresent the data related to member activity. As a result, the enterprise system 40 may not be able to accurately credit members with award points in a timely fashion. Thus, to address this and other deficiencies of the methodologies currently known in the art, the system 40 may employ an electronic feedback system for transaction triggers generally illustrated in FIGS. 9-14.

In particular, FIG. 9 schematically illustrates one such example feedback system 500 involving the enterprise system 40, a merchant 505, an e-mail service provider 508, and a user 510 operating a personal computer 512. As discussed above with reference to FIGS. 1, 3, 5, 7, and 8, the enterprise system 40 may have the architecture of an example system 150, 250, 350, or 400. It will be appreciated that none of the mechanisms illustrated in FIGS. 9-13 is limited to any particular implementation of the enterprise system 40, and that the specific system components illustrated in these figures are provided by way of example only. Meanwhile, the merchant 505 may be a commercial web site offering products or services, such as an online store or a subscription-based sports database, for example. The merchant 505 could also be a financial institution such as a bank, an online travel agency, a research web site collecting statistical data through surveys and questionnaires, or any other type of a business entity interacting with users of the enterprise system 40, as well as exchanging or purchasing demographic data from the enterprise 40. In addition to communicating via the user 510, as illustrated in FIG. 9, the merchant 505 and the enterprise system 40 may be connected via the Internet, intranet, or other network (not shown). Preferably but not necessarily, each of the enterprise system 40, the merchant 505, and the personal computer 512 are connected to the Internet and are capable of exchanging electronic information by means of electronic mail (e-mail), instant messaging, or other common communication format.

In operation, the system 40 conditionally allocates an award such as award points to the user 510 upon receiving an indication from the user 510 or from the merchant 505 that the user has completed a transaction with the merchant. In particular, the system 40 may credit the user by allocating award points if the reported transaction conforms to a business rule related to the merchant 505. When the user 510 completes a transaction with the merchant 505, the merchant 505 may automatically generate a confirmation message 520. In this sense, the merchant 505 may include a transaction trigger associated with one or more conditions such as completing a purchase, filling out a request for information, registering for a free or paid subscription, etc. In case of an online purchase, the confirmation message 520 may be similar to a paper receipt indicating the type of purchase, the price, the date of purchase, and other commonly included details. As discussed in greater detail below, the confirmation message 520 may be in one of the many textual, numeric, graphic, or mixed formats recognized by the enterprise system 40. In the particular example illustrated in FIG. 9, the confirmation message 520 is an e-mail message which the user 510 receives at an e-mail address maintained by the e-mail service provider 508. As is typical in Internet commerce, the user 510 may specify his or her e-mail address at the provider 508 prior to purchasing the product from the merchant 505 or while making the purchase. The user 510 may then decide to claim award points from the enterprise system 40 for having fulfilled a task specified by a corresponding business rule. In some cases, the merchant 505 may automatically recognize the purchase as potentially qualifying under one or more business rules. For example, the merchant 505 may be conducting a promotion on the type of product purchased by the user 510, and the promotion may involve awards allocated through the enterprise system 40. In this case, the merchant 505 may include additional text or image in the confirmation message 520 encouraging the user 510 to forward the confirmation message 520 to the enterprise system 40. For example, the additional text may state “you may qualify for up to 100 award points through www.mypoints.com!”

The user may then forward the confirmation message 520 to the enterprise system 40 in order to claim award points. It is contemplated that the user 510 may decide to include additional text in the confirmation message 520; however, the enterprise system 40 preferably relies only on the text and/or images included by the merchant 505. In one contemplated embodiment, the enterprise system 40 ignores the additional text included before or after the original content of the message 520. In either case, the forwarded confirmation message 520 may arrive to a well-known e-mail address associated with the enterprise system 40, such as confirmation@mypoints.com, for example. One of ordinary skill in the art will also appreciate that the enterprise system 40 may maintain a plurality of addresses, such as awards@mypoints.com and claimpoints@mypoints.com, and may automatically funnel all messages arriving at each of these addresses to a single process handling confirmation messages. In the particular example illustrated in FIG. 9, the message 520 may arrive at the e-mail relay system 448.

Referring to an example feedback system 530 illustrated in FIG. 10, the enterprise system 40 may alternatively require the user 510 to submit the confirmation message 52 to the web server 402 via a web form 530. Preferably, the web server 402 protects the web form 530 by means of a password or similar methodology. In this embodiment, the user 510 may access a public page associated with the enterprise system 40 and enter his or her authentication information. Upon verifying the supplied credentials, the enterprise system 40 may redirect the user 510 to a web page adapted to interactively accept text and/or images from the properly authenticated users. It will be appreciated that in accordance with this method, the enterprise system 40 reliably verifies the user's identity prior to accepting and processing the confirmation message 520. This verification step may be particularly useful if the merchant 505 does not encode the message 520, thus exposing the content of the message to potential tampering attempts.

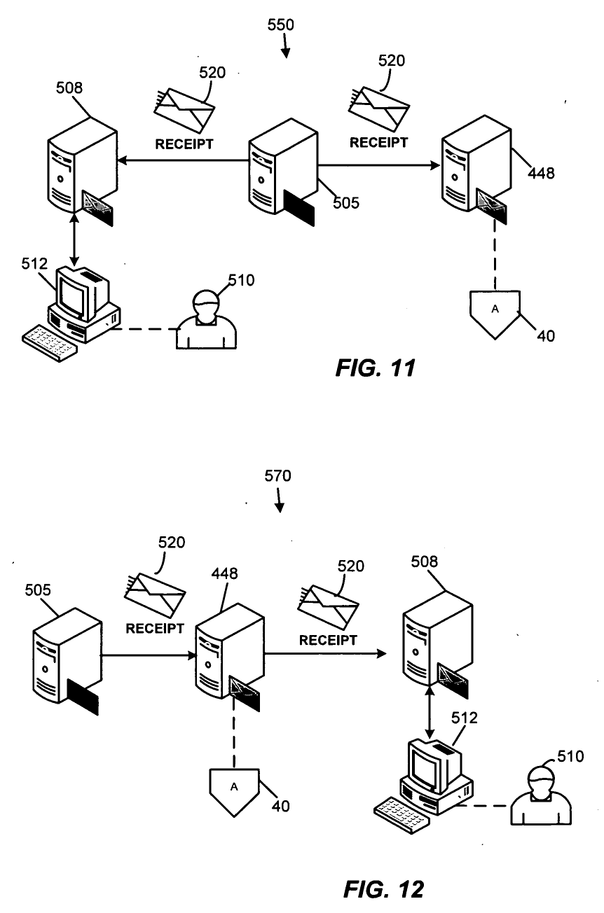

On the other hand, the merchant 505 in an example feedback system 550 (FIG. 11) sends a copy of the confirmation message 520 to each one of the user's e-mail account at the e-mail service provider 508 and the enterprise system 40. In accordance with this embodiment, the merchant 505 may direct all confirmation messages to a single e-mail address associated with the enterprise system 40. Optionally, the merchant 505 may include additional information in the copy sent to the enterprise system 40, such as data that may help identify the user 510 in the member database of the enterprise system 40 (e.g., user's identification number). Alternatively, the system 40 may maintain user-specific e-mail addresses at the e-mail server 448, with each e-mail address generated in a manner predictable to the merchant 505. For example, if a registered user has an identity number assigned by the enterprise system 40 and revealed to the merchant 505 while the user is making purchases, the merchant 505 could generate the e-mail address of the user at the enterprise 40 by appending a predefined domain name, such as mypoints.com, to the user's identity number. In either case, the enterprise system 40 may identify the user associated with the received copy of the confirmation message 520, recognize one or more business rules applicable to the transaction reported in the confirmation message 520, and allocate award points to the user upon verifying the contents of the message applying one or more techniques discussed below.

As another alternative, the merchant 505 may send a single copy of the confirmation message 520 to the enterprise system 40. The enterprise system 40 may then forward the message to the personal e-mail account of the user 510 upon processing the contents and, when necessary, updating his or her award account. This embodiment is illustrated as a feedback system 570 in FIG. 12. As in the example discussed above in reference to FIG. 11, the enterprise system 40 may need to identify the user 510 based on the information included in the message 520 in order to forward the message to the correct address. To this end, the enterprise system may search for the name, user identification number, address, and other personal information within the message. Alternatively or additionally, the merchant 505 may insert the identification information of the user into the body of the confirmation message 520. For example, the merchant 505 may prepare a confirmation e-mail for the user 510 and “wrap” the entire HTTP payload (i.e., message body along with the message header) inside the e-mail message sent to the enterprise system 40. Upon receiving the confirmation e-mail 520, the enterprise system 40 may then derive the identity of the user 510 from the body of the confirmation message 520 or, in another embodiment, from the e-mail message header.

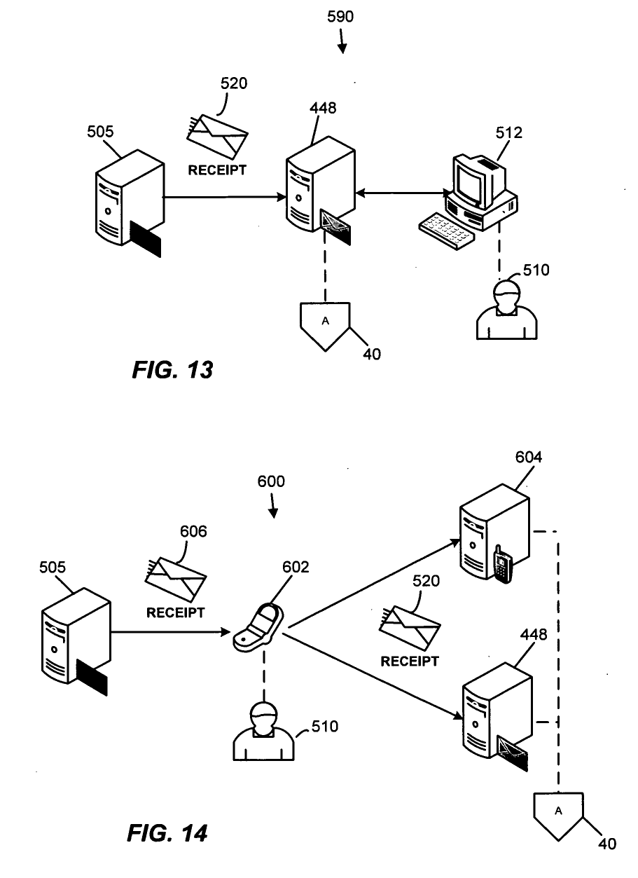

As yet another alternative, the system 40 may provide the user 510 with a personalized enterprise e-mail address maintained by the e-mail server 448 (FIG. 13). The e-mail server 448 is either a part of the enterprise system 40 or, at least, grants the system 40 access to the contents of some or all of the e-mail messages arriving at the server 448. In one possible arrangement, the e-mail server 448 may be a third-party server granting administrative privileges to the system 40 with respect to a block of e-mail addresses allocated to the registered users of the system 40. As illustrated in FIG. 12, the user 510 may access his or her e-mail account at the server 448 via a network connection by using the personal computer 512. It is contemplated that in this embodiment, the user 510 provides the enterprise e-mail address to the merchant 505 instead of his or her personal e-mail address. To ensure compliance, the enterprise system 40 may reject confirmation messages forwarded from other e-mail addresses and accept only those messages that the merchant 505 sends directly to the enterprise e-mail address. Additionally, the server 448 may provide an automated forwarding option so that the user 510 may receive all confirmation e-mail messages at an e-mail address of his or her preference. It will be appreciated that in accordance with this approach, the user 510 may access his or her confirmation e-mails without accessing the server 448 while the enterprise system 40 may process all confirmation messages, such as the message 520, both reliably and transparently.

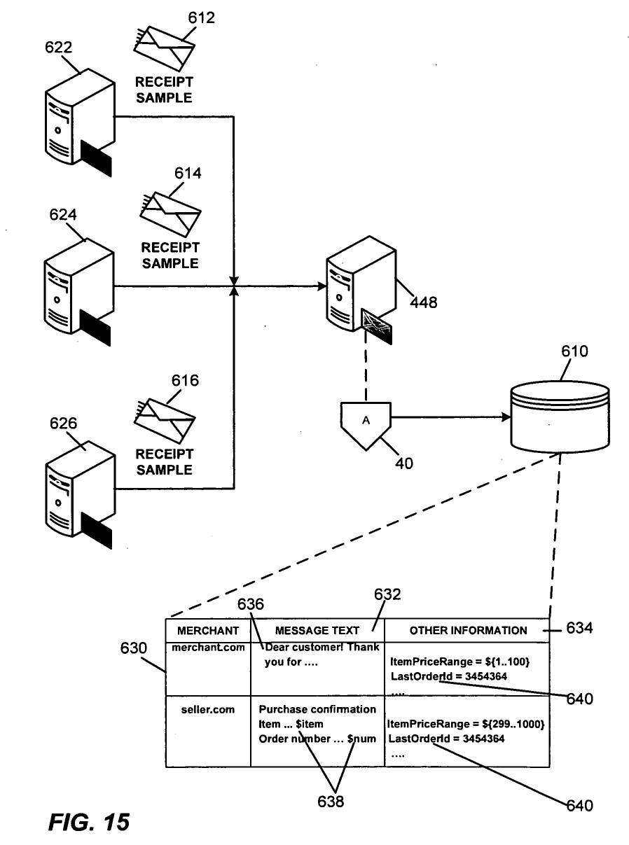

Of course, the confirmation message 520 need not be an e-mail message. As illustrated in FIG. 14, an example feedback mechanism 600 may include the merchant 505, a personal mobile device 602, and a short messaging center 604 working in co-operation with the enterprise system 40. In this embodiment, the merchant 505 may send an alphanumeric text message, a multi-media message (MMS), or any other type of message to the user's cellular phone or other type of a personal mobile device. As illustrated in FIG. 14, the user 510 may, in turn, forward the short message 606 to the messaging center 604 or to the e-mail server 448. One of ordinary skill in the art will further appreciate that the confirmation message 520 or 606 may also be an instant message, a chat message, or an electronic message conforming to a proprietary format. Further, it will be appreciated that the enterprise system 40 may use a combination of mechanisms 500, 530, 550, 570, 590, or 600. For example, the enterprise system may accept confirmation messages both as forwarded e-mail messages and as content submitted through the web form 530.

As mentioned above, the enterprise system 40 preferably employs an efficient and reliable means of assuring that the contents of the forwarded message 520 or 606 are authentic. Of course, some of the example mechanisms illustrated in FIGS. 9-14 may necessitate a greater effort in verifying the content of confirmation messages because these mechanisms provide relative freedom to users with respect to forwarding or submitting confirmation information. Referring back to FIG. 9, for example, the user 510 may be tempted to modify the message 520 prior to forwarding this message to the system 40. In particular, the user 510 may be tempted to increase the purchase amount to trigger a higher point award, modify the purchase or transaction date to qualify for a limited-time campaign, modify the name of the user to circumvent restrictions with respect to the qualifying customers, modify the name of the merchant to claim awards for transactions or purchases that did not in fact take place, or engage in other forms of fraudulent activity. Of course, the motivation of a user to counterfeit a message confirming a transaction is generally proportional to the award associated with the transaction. Thus, the enterprise system 40 may reasonably expect a greater probability of attempted fraud in those transactions that involve substantial amounts of award points. Also, the system 40 may draw additional statistical inferences from the past activity associated with a particular user, a particular merchant, or a particular product. Thus, by applying this and other types of statistical data, the system 40 may automatically detect potentially fraudulent confirmation messages and/or flag the suspicious messages for human review. Moreover, the system 40 may focus the effort to detect illegitimately modified confirmation messages by allocating a greater amount of time or processing power to those messages that have a higher probability of having been modified.

By way of one specific example, FIG. 15 illustrates a database 610 storing confirmation information related to all or some of the merchants cooperating with the enterprise system 40. In particular, the database 610 may store sample confirmation messages 612-616 from the merchants 622-626 in a table 630. Each record in the table 630 may correspond to an individual merchant and may include sample confirmation message text 632, as well as additional information 634. As one of ordinary skill in the art will recognize, each sample confirmation message text 632 may be stored as static alphanumeric text (e.g., string constants 636) including text variables preceded by sigils (e.g., variables 638), as an ordered list of keywords and variables, or in any other format suitable for parsing. In at least one possible embodiment, the application server 160 may execute a software application to compare the format of the confirmation message 520 or 605 to the confirmation message text 632 of the corresponding merchant. More specifically, the application server 160 may parse the confirmation message 520 or 605 to identify the merchant information included in the message, separate static text elements from variable text elements, retrieve the record corresponding to the identified merchant from the database 610, and compare each static element of the confirmation message 520 or 605 to the sample confirmation text 632.

Additionally, the application server 160 may apply any known statistical methodology to process the specific transaction data included in the confirmation message 520 or 605 according to the additional information 624 related to the identified merchant. For example, the application server 160 may extract the purchase, order, or transaction identifier from the confirmation message 520 or 605, compare the extracted identifier to the last order identifier 640, and assess the probability that extracted identifier is legitimate. Similarly, the application server may statistically analyze such values reported in the confirmation message 520 or 605 as the amount of purchase, unit price, number of items, etc. For example, the application server 160 may detect an abnormally high price of a product in a confirmation message and flag the message accordingly. To this end, the application server 160 may consult other database tables in addition to the table 630. Moreover, the application server may consult multiple databases while processing confirmation messages, such as a database storing product information or a database storing merchant information. It is contemplated that the application server 160 may retrieve member information from the member silo 154, for example, to compare the member's purchase patterns to the purchase reported in the confirmation message 520 or 605.

In one embodiment applying restrictions to the confirmation message 520 or 605 based on the previous member activity, the system may award a limited number of points to a member per unit of time (e.g., 25 per day) or limit the number of submissions per unit of time (e.g., 5 per day). In addition to detecting excessive submissions and identifying potentially fraudulent member activity, this approach may be used as an additional safeguard in combination with other methods of inspecting confirmation messages 520 or 605. Of course, this approach may also limit the amount of award the system allocates in response to receiving fraudulent confirmation messages if the system fails to detect fraud in these messages.

Additionally or alternatively, the system may check the header of the confirmation message 520 or 605. In general, the headers of email messages may differ in date-time stamps on various hops for delivering the email and, at least for some senders, there are extra headers that would be expected to vary in certain ways from one email to another. An unsophisticated fraudster may not think to try to fake the headers in a realistic way when copying an email repeatedly. Further, some header types are standard across all types of email while others may be merchant-specific. Fraud analysis can be automated for each merchant once a few email samples are available.

In addition to comparing the order identifier in the confirmation message 520 or 605 to the last order identifier 640, the application server 160 or another component of the information gathering system may further analyze the received order identifier if multiple samples of email confirmations with valid order identifiers are available, preferably spanning a statistically significant period of time. In particular, if the application server 160 discovers that a certain merchant assigns order identifiers in some discernable sequence, the application server 160 may determine a correlation from these samples, so that when a new confirmation message 520 or 605 arrives, the order identifier, along with the purchase date and time in the new confirmation message can be compared with the known sequencing. In this manner, the application server 160 may determine whether the order identifier appears to be out of the expected sequence and flag the corresponding confirmation message 520 or 605 as suspicious.

Further, with a sufficient number of samples, the application server 160 can approximately estimate the number of order identifiers that may be expected to have been consumed in the sequence between any two given purchase dates and times, allowing the application server 160 to predict what range of order identifiers would likely be associated with a given purchase date and time. A first approximation may simply examine the average number of order identifiers (in the sequence pattern) that occurs over some range of time, such as daily. However, a better approximation would take into account variations in the average order identifiers per day based on past examples of purchase date and time values in email confirmations and their observed order identifiers. For example, the variations may include correlations with day of the week (there may be more orders during a typical weekend than on weekdays), month of the year (seasonality), and a long-term trend (a merchant whose rate of sales are gradually growing). Additionally, the variance of the expected number of orders can be estimated against different parameters (day of week, month of year, trends over time, etc.) so that a range of order identifiers can be predicted, in a statistically reliable manner, for a given purchase date and time either in the future or in the past.

On the other hand, duplicate order identifiers may be detected by comparing just the sequenced portion of the order identifier, rather than requiring a duplicate match on the entire order identifier. Furthermore, expectations of randomness in parts of the order identifier may also be checked, such as characters that may correspond to a checksum or other encryption or security feature of the order identifiers generated by a merchant. Thus, for example, a security code that fails to vary when the sequential part varies is a suspicious occurrence unless this lack of variation happens only as frequently as expected by a random distribution over the number of possible apparently random values.

When duplicate order identifiers are detected, the online marketer, such as the information gathering system discussed herein, may then need to determine which of the two identifiers is valid and which one is fraudulent, or whether the duplication is merely two submissions of the same email confirmation by the same member, (which may well be unintentional). If the contents of the two email messages match in their respective content (order identifier, date and time of purchase, description of purchase, name and address of the purchaser), and are submitted by the same member, this type of duplicate submission may be disregarded. On the other hand, if two orders with order identifiers that match on the sequential portion of the order identifiers are submitted by two different members, then the online marketer must decide which user has submitted a fraudulent email confirmation. In one embodiment, the application server 160 or another service associated with the online marketer may count the number of duplicate order identifiers submitted by each member and, when a duplicate is encountered, mark the member who has already several duplicates as suspected fraud. Conversely, the application server 160 may not consider a member suspicious if the member has rarely or never before been involved in a duplicate order identifier submission. Here, it may be noted that if a member engages in frequent submission of fraudulent order identifiers by making up identifiers, these identifiers are likely to match a random set of other member-submitted email confirmations. Thus, the rate of duplication would make it apparent what the source of such extensive fraudulent activity is.

Further, if the format of an order identifier does not match an expected format (with the expectation derived from multiple previous examples), then the identifier may be rejected as likely to have been made up, i.e., fraudulent. This could occur, for example, by careless modification of a real order identifier where the change is not consistent with previously observed examples of the order identifier from a given merchant. Such incompatible modifications might include, for example, changing the number of characters in the order identifier, or placing punctuation characters in different places (such as dash), or putting lower case characters where only upper-case characters are expected, or placing alphabetic characters where only digits are expected, or modifying values that are otherwise apparently constant for long periods of time (such as characters that indicate year of purchase).

For example, the online marketer who receives email confirmations from a plurality of participants (such as members of a loyalty program) may record observations as illustrated below for the confirmations associated with BookSellerTwo.com, for example:
1/14/07 10:35 AM order ID 4899-3903-07-A27
1/15/07 12:47 PM order ID 4899-3953-07-XV3
1/19/07 4:27 PM order ID 4899-4088-07-V29
1/19/07 4:56 PM order ID 4899-4092-07-Q4K

From these observations, the online marketer may notice, upon comparing order identifiers, that the second set of four digits appears to increase monotonically with date and time, while the last three characters appear to be random and may be, for example, a checksum or other security feature of the order identifiers, known to the merchant but not to the online marketer. The “4899” and “07” portions appear constant for a longer period of time, as are the positions of the dash characters. Also, upper-case letters apparently can be expected, but only in the last three character positions, and seemingly at random.

In this example, the application server 160 can estimate the rate of sequencing of the order identifiers by noting that the sub-sequence starts with 3903 and ends with 4092 over the period 1/14/07 10:35 AM to 1/19/07 4:56 PM, giving 185 order identifier sequence values over a period of 4 days 5 hours and 21 minutes. The following order identifiers, then, would appear suspicious based on the principles described above:
1) 1/15/07 11:04 AM order ID 4899-3962-07-WW2:
3962 would be expected to occur after 12:47 PM on the same day because of the other order already observed at that time with a lower sequence number of 3953.
2) 1/12/07 7:39 AM order ID 4899-3900-07-A22:
This identifier is only three sequence values less than the value observed on 1/14/07. At the typical rate of sales for this merchant, an order from over two days earlier may be expected to have a much lower sequence number. With a mathematical analysis of the rate and variance of sequence numbers, the information gathering system could even identify a precise range of order identifiers reasonably expected for the date and time of 1/12/07 7:39 AM. These identifiers may be, for example, 3801 to 3825, but 3900 does not fall into this range.
3) 1/12/07 7:39 AM order ID 4897-3822-06-a22v:
In this case, the constant portions do not match the expected values (4897 does not match 4899 and 06 does not match 07), the random portion contains an unexpected character (a lower-case ‘a’), and the length is not right (with an extra ‘v’ at the end).

It will be noted that similar techniques of authenticity checking may be applied to other data in an email confirmation. For example, these techniques may be applied to the format and appearance of the purchase date and time itself (whether upper case or lower case characters are used, for example). Further, these techniques may be applied to SKU numbers associated with purchased products, to the descriptions of products, or to the prices of products.

It will be also appreciated that in addition to the application server 160, the analysis of the confirmation message 520 or 605 may be carried out at the e-mail server 448 or at another component of the enterprise system 40. Further, the system 40 may also perform the analysis of incoming confirmation messages in a distributed manner. Still further, certain steps of analyzing confirmation messages may be performed manually by an operator or automatically by the enterprise system 40. In at least one contemplated embodiment, the system 40 flags suspicious messages for subsequent manual inspection. In other possible embodiments, the system 40 does not require manual involvement and rejects messages that fail cryptographic verification.

As one familiar with the general principles of internet security will recognize, data encryption seeks to prevent at least the falsification of identity and the falsification of content. In some cases, malicious data contains authentic content but misrepresents, or “impersonates,” the sender. For example, the user 510 may send an e-mail message on behalf of the merchant 505. In other cases, attackers modify the content of the message while leaving the sender's identification intact. For example, the user 510 may modify the purchase amount in the message 520 prior to submitting the message to the system 40. To combat these and similar issues, senders and receivers of network data typically use the well-established Public Key Infrastructure (PKI). In general, Public Key encryption involves a public key and a corresponding private key. The owner of the private key publishes the public key in form of a certificate, for example, while securely storing the private key. As the names of the keys suggest, virtually any network user can easily access the public key to encode a message to the private key owner. However, only the private key owner can decode the encoded message. Conversely, only the private key owner can produce a substantially unique sequence of data by applying the private key to a message, while any receiver can transform the encoded sequence back into the original message by applying the corresponding public key. The convenience and security of Public Key cryptography lies in the asymmetry of underlying mathematical operations involved in decoding and encoding operations using the same key. In other words, the effort to decode a message, previously encoded with a public key, using a matching private key is very small compared to the effort of a potential attacker to decode the message knowing only the public key. As one example, this asymmetry is sometimes achieved by prime factorization: the effort to multiply two large prime numbers is not commensurate with the effort to identify all prime factors of a large number.

Some of the widely used communication protocols support these or similar encryption techniques. For example, the Secure Socket Layer (SSL) protocol provides Public Key cryptography and supports certification through a trusted third-party provider known as Certificate Authority (CA). In general, a CA issues a small file known as certificate to a user which may include the user's public key and other information. Importantly, the CA digitally signs the certificate by applying the private key of the CA and includes the signature in the issued certificate. The user then makes the certificate available to the public which is assured of the certificate's authenticity by the digital signature of the CA. In the subsequent communications, the user may sign outgoing data by applying the private key. As discussed above, the receivers of the data signed by the user may apply the public key included in the published certificate to verify the integrity of the data. Among other advantages, SSL and CA-based certification allow users to easily obtain private and public key pairs, and enables the general public to perform secure transactions in relative safety. To take one example which customers of online stores may easily recognize, the standard HTTP protocol used by a typical Internet browser usually changes to the secure HTTPS protocol during exchange of such private data as credit card numbers or birthday data. HTTPS includes SSL layered over TCP/IP, and uses certificates (shipped with the browser or obtained from a trusted source) to ensure security of network communications.

Referring again to FIGS. 9-14, the merchant 505 may apply the technique discussed above and digitally sign the confirmation message 520 or 605. In particular, the merchant 505 may apply the merchant's private key and provide the corresponding public key to the system 40. Alternatively, the merchant 505 may encode a portion of the message 520 or 605 and leave the rest of the message in a readable form. For example, the merchant 505 in the arrangement illustrated in FIG. 9 may include the confirmation information for the user 510 in an un-encoded format and may additionally include the same or similar confirmation information in an encoded format. The user 510 may then forward the entire message or only the encoded portion to the system 40. As an alternative, the user 510 may also apply his or her signature to the message 520 or 605 by way of additional assurance or acceptance of liability, for example. As another alternative, one or both of the merchant 505 and the user 510 may use the recently introduced DomainKeys Identified Mail (DKIM) technology, which allows senders to sign outgoing messages and receivers reliably verify these signatures. In this case, the user 510 or the merchant 505 must supply the entire message, completely intact and including email header information, because the entire message is required for authentication. It will be also noted that DKIM can additionally reduce spam because the recipients of email messages may have a greater degree of confidence in the identity of the sender. However, even though many email senders routinely use DKIM, none of these current users apply DKIM for the purposes discussed herein. Of course, the techniques such as those illustrated in FIGS. 9-14 may also use any other methodology which prevents or, at least, significantly impedes tampering with the content of the confirmation message 520.

As yet another alternative, the merchant 505 may encode a portion of the message 520 using the public key associated with the enterprise system 40. It will be appreciated that by using the public key instead of a private key, the merchant 505 may eliminate the need to obtain its own private key, thus reducing the overall number of encryption key pairs required in the system. To make this approach secure, the merchant 505 and the enterprise system 40 may agree on a non-obvious confirmation message format and may make this format inaccessible to members such as the user 510. In other words, the merchant 505 and the system 40 may effectively define a private message format. This way, only the merchant 505 may produce a substantially unique sequence of data by applying the public key of the system 40 to a message formatted according to the unpublished private format. Meanwhile, only the system 40 may decode the message by applying the securely kept private key.

It will be appreciated that the methods of verifying message integrity and identifying fraudulent data can be also applied to other types of information, such as product reviews submitted by members in exchange for award points, for example. Because one member could simply re-post a review submitted by another member, with none or only trivial modifications, the information gathering system preferably applies the fraud detection methodology discussed herein to some or all member reviews. Furthermore, members could fake reviews of products they did not actually purchase just to get rewarded. By requiring an authenticated email confirmation of the purchase as a pre-requisite to earning a reward for a submitted product review, this type of fraud may be substantially reduced.

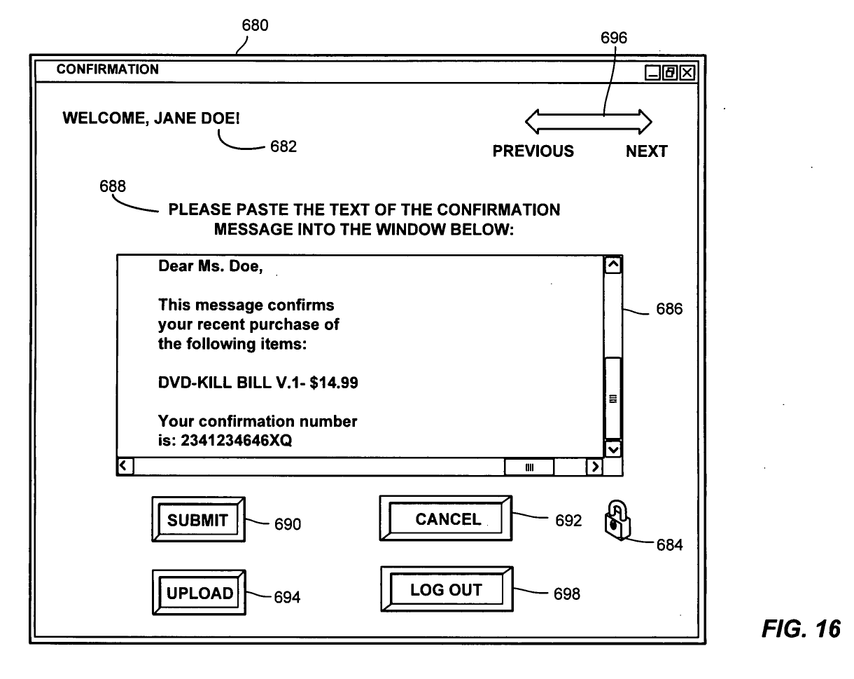

Referring back to FIG. 10, the web server 402 may display a web form 680 via a web page accessible to the user 510. In accordance with one possible embodiment, the web server 402 authenticates the user 510 prior to granting him or her access to the web form 680. As one of ordinary skill in the art will appreciate, the authentication information may include login identity, password, a challenge phrase, or cached authentication information passed to the web server 402 by the user's browser application in form of a cookie. Of course, the web server 402 may also authenticate the user 510 in any other suitable manner, including those known in the art. In the example illustrated in FIG. 16, the web form 680 includes a personalized greeting 682 which assures the user that he or she has been recognized by the enterprise system 40. Additionally, a security indicator 684 may further assure the user that the web form 680 is secure. The indicator 684 may refer to a secure protocol such as HTTPS or to some other method of data protection.

With continued reference to FIG. 16, the user may type in or paste the contents of the confirmation message 520 or 605 into a window 686, preferably marked with a prompt 688. In addition to ASCII characters, confirmation messages in at least some of the contemplated embodiments may include Unicode characters, images in bitmap, JPEG, or other formats, and other non-textual information. The window 686 may accept data in a variety of formats or, alternatively, may filter out unsupported characters and/or images as the data is entered.

The user 510 may submit the data entered into the window 686 by activating the button 690 or cancel the entry by means of the button 692. Additionally, the web form 680 may allow upload of an entire confirmation message as an HTML file, Rich Text (RTF) file, or in any other standard format. The user may activate this option by operating the button 694, for example. Next, upon entering or uploading the confirmation message, the user may select to enter another confirmation message or to return to a previously entered or upload confirmation message by operating the control 696. If, on the other hand, the user does not wish to enter additional information, he or she may securely exit the web form 680 by operating the button 698.

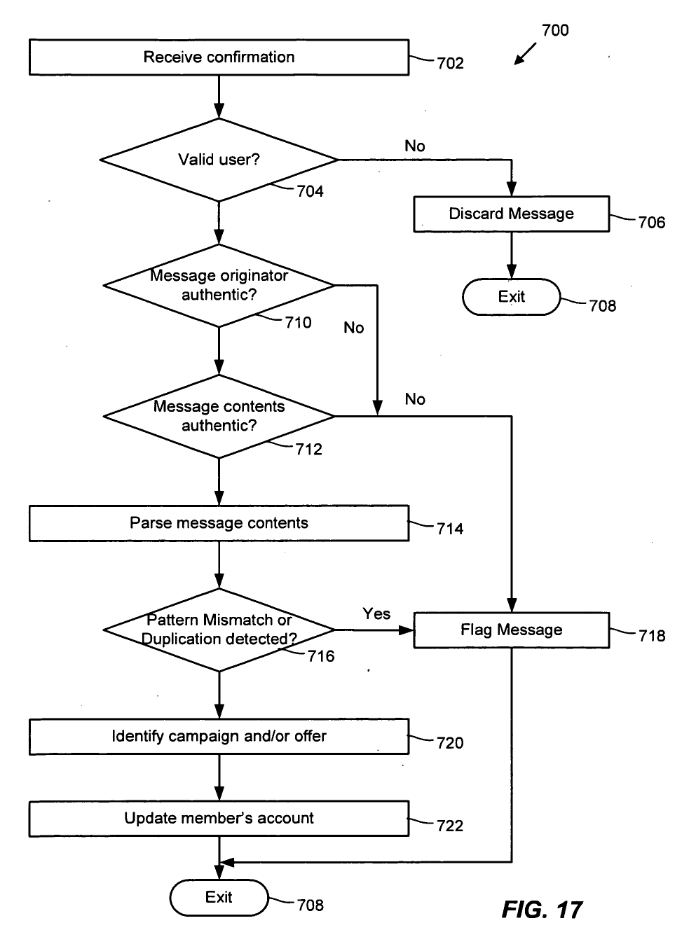

After the enterprise system 40 receives one or more confirmation messages via the web form 680, the e-mail server 448, or in any other manner including those discussed above, the application server 160 or another one or several components of the system 40 may execute a routine 700 to process one or more messages (FIG. 17). In particular, the routine 700 may receive an individual confirmation message 520 or 605 in a block 702 and, optionally, additional data related to the message supplied by the e-mail server 448 or web server 402, for example. In a block 704, the routine 700 may check whether the user identity included in the message 520 (or in the additional information supplied along with the message) is a properly registered user. To this end, the routine 700 may consult the member silo 154. If the user specified in the confirmation 520 or 605 is not recognized as a registered member of the system 40, the routine may discard the message in a block 706 and exit in a block 708. If, on the other hand, the user's registration is successfully verified, the routine proceeds to verify the originator of the message in a block 710.

As discussed above with respect to general principles of data encryption, the block 710 may involve applying a private key to the signature of the message 520 to assure that the identity of the sender has not been misrepresented. Similarly, the routine 700 may verify the integrity of the contents of the message in a block 712. If the routine 700 does not detect tampering in the blocks 710 or 712, the routine 700 may convert the encoded contents to the original format and parse the message in a block 714. In particular, the block 714 may include searching for key words, identifying variable text, extracting the identity of the user, date and time information, product and transaction identification, and other relevant data. Next, in a block 716, the routine 700 may compare the confirmation message to the transaction history of the member identified in the block 704. As indicated above, the user 510 may purposefully or inadvertently submit the confirmation message two or more times to the system 40. Thus, the block 716 may include retrieving all or part of the member's transaction history from the member silo 154 and checking the date and time of purchase, the order or transaction identification, the purchase amount, and other data against the relevant part of the member's transaction history.

If any of the blocks 704, 712, or 716 indicate a possibility of modified content or duplicate data, the routine 700 may flag the confirmation message in a block 722. It will be appreciated that block 722 may include various forms of flagging suspicious data, such as setting a dedicated variable in a database, forwarding the suspicious message to another module for detailed automated inspection, forwarding the suspicious message to an operator for manual inspection, discarding the message, generating an automatic reply to the user requesting additional proof of purchase, or other activities. If, on the other hand, the routine 700 does not find any potential problems in the confirmation message, the routine 700 identifies the campaign, offer, and/or other relevant business rule information (block 720). More specifically, the routine 700 may search the business rules associated with merchant identified in one of the earlier blocks 704 or 714 to detect whether the reported transaction qualifies for one or more point awards. Finally, the routine 700 may allocate the necessary award to the user's account in a block 722. Optionally, the block 722 may also include sending a confirmation message to the user specifying the number of awarded points and other relevant details.

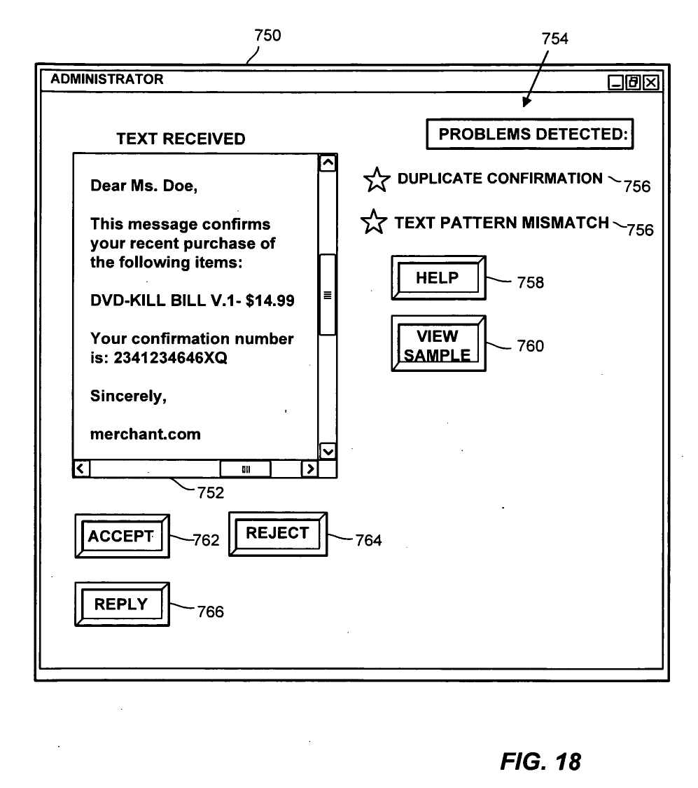

Referring to FIG. 18, a human operator may manually process some or all of the messages flagged in the block 718. As one of ordinary skill in the art will appreciate, automated detection may sometimes generate “false positives,” or potential problems that a human operator identifies as non-problems upon a closer inspection. Thus, in accordance with some of the possible embodiments, the enterprise system 40 may direct the flagged message to a dedicated queue or a database, and an operator may view the flagged message to decide on the best course of action (e.g., rejecting the confirmation message, accepting the message and allocating award points, asking the user or the merchant for additional information). As illustrated in FIG. 18, the interface 750 may present the text of the flagged message in a window 752. Preferably, the window 752 presents the message in the same original format, i.e., the window 752 may preserve such meta-textual data as hyperlinks, font and color indicators, etc. In those embodiments where the system 40 applies both encryption and statistical methods such as pattern matching, the window 752 may present the decoded, readable text. In these cases, the interface 800 may display only those messages that have passed the encryption test.

The interface 750 may include a problem indicator area 754 including problem descriptors 756, a help button 758, and a sample button 760. More specifically, each of the problem descriptors 756 may describe a particular problem identified at an automated stage of the processing, such as during execution of the routine 700. The user may retrieve additional information related to the reported problems by operating the help button 758. Additionally, the user may view a sample receipt or confirmation message associated with the merchant, particularly in those cases where the interface 750 reports format or pattern mismatch. Referring back to FIG. 15, the database 610 stores samples for at least some of the merchants 505 and 622-626. Thus, the interface 750 may retrieve the relevant part of the table 630 in response to the operator activating the sample button 760.

Upon inspecting the flagged confirmation message, the operator may accept the message by pressing a button 762 or reject the message by pressing a button 764. Of course, the interface 750 may also present additional screens to the operator to select other options such as placing the member's account on hold, for example. Also, the interface 750 may present the operator with an option to reply to the merchant or to the user in order to follow up on the transaction, request additional information, etc.

It is also contemplated that the enterprise system 40 may use a self-teaching technique to improve the detection of falsified confirmation messages when applying pattern matching techniques and other statistical approaches. For example, the system 40 may train an artificial neural network with the initial samples 612-616 and subsequently re-train the network each time an operator confirms or rejects the automated decision of the routine 700.

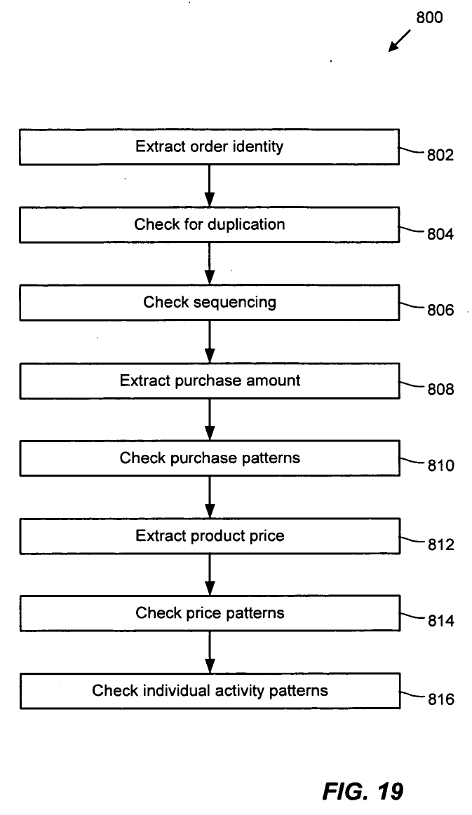

Referring to FIG. 19, an example parsing routine 800 may be invoked at the block 716 of the routine 700. It will be appreciated that the blocks 802-816 may be also executed in a different order, by different components of the system 40, and at separate stages of processing of a received confirmation message. In a block 802, the routine 800 may extract a number or an alphanumeric string which identifies the transaction such as purchase, subscription, completion of an application, filling out of a survey, etc. The routine 800 may then check the number for duplication (block 804). In particular, the block 804 may include searching for other transactions reported by the same merchant to see whether the same number has been previously reported. Thus, the block 804 may include checking the information of all members interacting with the merchant. In addition to checking for duplication, the routine 800 may use a probabilistic approach to ascertain the probability that the number is correct (block 806). For example, the routine 800 may compare the reported order identifiers 1,220,345 to the order identifiers previously reported by the same merchant, which may have been in the 5-digit range. Based on this historical data, the routine 800 may flag the confirmation message because the included order identifier appears suspicious. Of course, the routine 800 may further improve the accuracy of such predictions by considering the time interval between the previously reported order identifiers and by making seasonal adjustments (e.g., Thanksgiving shopping typically involves more spending).

Next, the routine 800 may extract the purchase amount in a block 808. In a manner similar to processing order number sequencing, the routine 800 may compare the purchase amount to the purchasing habits of the member as evidenced by the member's historical record (block 810). Further, the routine 800 may extract the per-unit price of the product or service reported in the confirmation message (block 812). In the subsequent block 814, the routine 800 may analyze the product price by checking one or multiple merchants. Thus, in at least one embodiment or under certain conditions, the routine 800 may focus on the previous sales of the same product and only by the merchant identified in the confirmation message, whereas in other cases the routine 800 may further check the pricing of the same or similar product by other merchants. Finally, the routine 800 may check for other patterns in the member's historical data to determine whether the confirmation message likely contains accurate data (block 816). For example, the routine 800 may look at the time of purchase to determine whether a transaction reported at 2:00 a.m. matches the historical record of the member.

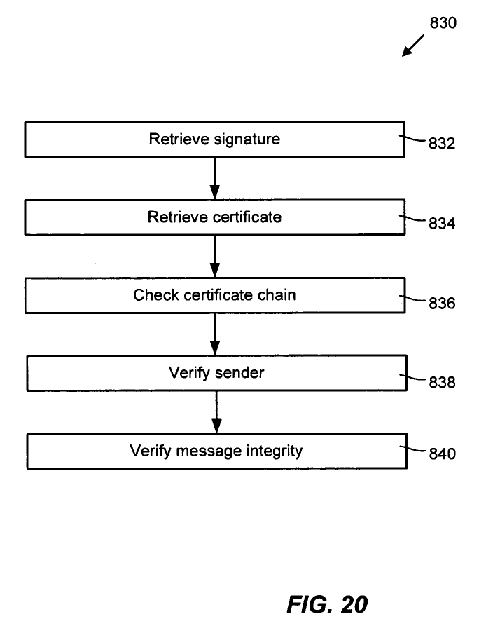

FIG. 20 illustrates an encryption verification routine 830 which the enterprise system 40 may invoke to check the integrity of an e-mail message, text message, web form data, or confirmation information reported to the system 40 in some other manner. In particular, the routine 830 may include the blocks of retrieving the signature of the sender (block 832), retrieving the appropriate certificate (block 834), and verifying the chain of certification (block 836). Of course, the routine 830 need not retrieve the certificate or verify the chain of certification in all circumstances. For example, the merchant 505 may sign the confirmation message using the public key associated with the enterprise system 40. In this case, the routine 830 may simply apply the private key to decode the message. If, on the other hand, the merchant 505 obtains a certificate from a CA and signs the confirmation message using a private key, the system 40 may not store the corresponding public certificate. In this case, the merchant 505 may supply the certificate corresponding to the merchant's private key as a separate message or as an attachment to the confirmation message, for example. Alternatively, the merchant 505 may direct the system 40 to a publicly accessible network location storing the certificate. Next, the routine 830 may verify the integrity of the sender in a block 838 and verify data integrity in a block 840. As one of ordinary skill in the art will recognize, the blocks 838 and 840 may also be performed as a single operation. For example, the merchant 505 may generate the signature by calculating the message digest over the entire message, including both the payload and the sender information.

It is further contemplated that in addition to providing awards to members upon analyzing an email confirmation or other types of purchasing triggers, an information gathering system such one discussed above may award members for submitting other information related to the members' shopping habits at large. Importantly, this information need not be limited to the participating merchants. In particular, a service associated with the information gathering system may collect samples of emails from various online product and service providers, extract relevant information (e.g., user name, purchase amount, purchase date, authenticate the message (e.g., by using DomainKeys to verify that the integrity of the message), and provide the extracted information to other merchants as a service. Additionally, the service may automatically learn how to perform such acts as extracting the necessary information, for example. To this end, the service may use a feedback mechanism, a neural network, or other methods of adjusting and improving automated decisions. In some possible embodiments, the system may award members for submitting this information on a transactional basis or in proportion to the reported amount spent at a non-participating merchant, for example. However, the system need not necessarily award points or discounts to a member for submitting this information because the member may be motivated to submit this information for other reasons such as bookkeeping.

In one such embodiment, the members may keep electronic receipts as evidence of various purchases which may be provided to insurance companies, the Internal Revenue Service, etc., if necessary. The insurance company could use the service to authenticate the receipts. In other words, the insurance company may have a higher degree of comfort when relying on receipts previously analyzed and verified by the information gathering system. On the other hand, the members may appreciate the convenience of storing electronic receipts in a centralized repository, as well as of submitting these receipts to an insurance company with an at least partial assurance by the information gathering system.

Moreover, the service would solve another growing problem in the age of e-tailing: in the past, consumers would typically keep paper receipts in a safe deposit box or filing cabinet as evidence of purchases and would provide these receipts to the insurance company. The information gathering system may thus eliminate this need. In this regard, the service may operate as an “online safe deposit box,” which may be understood as a new type of a web service. In a sense, the information gathering system may operate as an information gathering and storage system. A member (i.e., a registered consumer) would simply forward all of his or her email confirmation slips to the service for safe-keeping. The member could then browse these confirmation messages by logging into his or her online safe deposit.

Of course, the online safe deposit also may be a convenient way to keep track of one's own purchases. For example, the service may allow a member to easily organize his or her confirmation messages by categories, by merchant information, etc. As mentioned above, the service may support a selection and submission function for forwarding all or some of the confirmation message to the insurer or other party authorized by the member. In some embodiments, the service might be offered to members free of charge, and may be financed by advertising banners directing the members to sites selected, in part, by identifying the items purchased in the confirmation emails.

Thus, the online safe deposit box discussed above may allow members to organize their online spending by easily seeing from which merchants they have previously purchased products or services. Moreover, a member can easily check how much money he or she has spent and what he or she has bought over a period of time. On the other hand, the information gathering system may use this information for effective targeted advertising.

In yet another aspect, a service providing an online safe deposit box may operate as part of a loyalty-based social service. For example, the information gathering system may extend the following offer to some or all of the members: “Get 5 points for each email confirmation you receive online and forward to us!” Alternatively, the system may suggest: “organize your online purchase information to see how much you are spending! And make it easy to submit receipts for insurance claims, should that ever be an issue!” As yet another alternative, the system may propose: “Submit reviews for the purchases you forward and get even more points!”

An online marketing service (such as the information gathering system or teh enterprise system discussed above) can provide some benefit, such as a free service, points in an award program, gifts or discounts, etc, in exchange for users voluntarily submitting their email confirmations of purchases to the advertising service (such as the loyalty-based social service provided by the information gathering system). In contrast to giving points or discounts to users on behalf of the merchants who sent the confirmation emails, or in direct response to other members' actions performed at the merchants' sites, this service effectively awards members for the information related to non-participating merchants. Thus, rather than giving benefits for actions taken at the merchant, the loyalty-based social service (or the advertising service) offers benefits for the act of merely submitting the email confirmations. Importantly, it is not necessary for the merchants to be willing participants of the service, or to have an arrangement with the advertising service. The online marketing service may use the received information related to non-participating merchants to generate financial parameters such as spending metrics, brand purchasing habit metrics, advertisement and promotional metrics, etc. As one example, a promotional metric may include an estimate of the volume of advertisement by a particular merchant or across a particular sector. Further, the online marketing service may use information related to other types of non-participating entities (e.g., business entities, social groups, schools, etc.) to derive other demographic information about one user or a group of users such as, for example, personal habits, behavioral trends, etc.

In addition to the separate benefits of awards or gifts, the member can also get another benefit from the marketing service by organizing the purchase receipts in an online safe deposit box. As mentioned above, the member can easily submit receipts for insurance claims from this service. Additionally, the member can organize information about his or her purchases for his or her own use and for the use of those whom the member grants access to this information. In particular, the member and, possibly, a trusted party can see a “statement” constructed from the content of the email confirmations showing the online purchases organized by merchant, type of service (travel, retail goods, education, etc.), and date range (month and year). In some embodiments, the format may be similar to a “year-end statement” which some credit cards provide to some card-holders.

With respect to a member permitting others to see the information related to his or her purchases (e.g., amount, merchant name, purchase date, etc), it will be noted that these purchases are confirmed and are therefore reliable indicators of the member's actual online purchasing behavior, making the information much more useful for online marketers. Because the email confirmations can be verified using DomainKeys and/or other methods of analyzing content patterns discussed above, the information is more reliable than self-reported purchases. Moreover, this information is more extensive than a report of purchases from the participating merchants actively co-operating with the information gathering system, at least because email confirmations need not be restricted to purchases made at participating merchants.

Further, other members who may know the member submitting the type of information discussed above can easily see what merchants and types of products are favored by the member if he or she gives permission to others to see this information. For example if a certain member tends to purchase books from ToolSeller.com and BookSeller.com, and tends to accordingly purchase tools and books, a friend of this member may reasonably infer which gift may suit him or her well, for example.

Still further, members who tend to shop at the same merchants can be placed into an online forum, maintained or at least associated with the information gathering system, where they can easily share their opinions about the buying experience, rate merchants, etc. The forum can be made more credible by reporting an indicator of purchase activity by the user at each merchant, based on the reliable information from the email confirmations. In other words, the information gathering system may effectively vouch for the forum participants to make other participants more comfortable when acting in reliance on the information obtained through the forum. If desired, the forum may disclose relatively little specific information about a particular member. In other embodiments, a member may control the amount of information related to his or her profile to be exposed to the other forum participants. In one example, the forum could say “Joe Smith is a frequent purchaser at ACME Book Store and “Sue Jones is an occasional purchaser at BookSeller.com.” The forum may automatically determine which of the terms frequent, occasional, etc to use in view of the relative purchasing frequency as compared to other customers of the same merchant, for example. In particular, the forum may look at how many dollars other members spend at this merchant, how many orders other members place within a predetermined period of time, etc. In this manner, the indicators may still be reliable even if users do not submit a complete history of their purchase confirmations. At the same time, privacy can be protected by not revealing the exact purchase amounts or order details.

It is contemplated that an online marketer may be willing to provide benefits such as free services or award points because confirmed information on a consumer's online purchase behavior is very valuable. As discussed above, the emails may be reliable because the system verifies these emails with a degree of confidence which, in at least some of the embodiments, may be very high. Because the merchants need not be active or even willing participants, and because the consumer need not submit more sensitive documents such as credit card history, the system and method discussed above allow access to accurate data indicative of actual consumer behavior. In particular, this information may include the actual email address used by a consumer to receive purchase confirmations, or information on which merchants are popularly favored by consumers, including merchants which the online marketer may wish to reach and who are not currently clients of the marketer. More specifically, the information gathering system may gather valuable information related to the competitors of the current clients of the information gathering system, so that cross-marketing of competitive products and services becomes possible (e.g., collecting information related to BookSellerOne.com which may be valuable to BookSellerTwo.com, a client of the information gathering system). Moreover, the information gathering system, alone or in co-operation with a participating client, may send advertisements of BookSellerTwo.com to those members whose submitted purchase data identifies them as BookSellerOne.com customers.

Other types of information which the information gathering system may derive may include a very reliable indication of how much online purchasing a particular member engages on a monthly basis, a similarly reliable indication of what items the member tends to purchase, a member's shipping address (yielding information about geography of the member even if the member does not otherwise provide this information directly to the marketing service).

It will be appreciated that this information can be very useful for high-quality targeted advertisement campaigns for other products and services. When the information is solicited as discussed herein, a member may provide this information more willingly than if he or she is simply asked such direct questions as “please provide your address,” “what is the email address you usually use for online purchases”, “at which merchants do you usually shop?,” “how much did you spend online in the past six months?,” “have you ever rented a video online?,” etc. It is contemplated that at least some members may be more likely to submit their email confirmation messages than to answer these pointed questions directly. In short, a member may be willing to submit confirmation information for several reasons: 1) to get a separate benefit (free services, points, free products, entry into sweepstakes, etc.), 2) to get direct benefits (online statement organizing their purchase history, online safe deposit for easier insurance claims related to goods purchased online, and 3) to get social benefits (sharing information about his or her taste and interests with others).

Also, it will be noted that the method of collecting information related to activities related to non-participating merchants outlined above allows for a simple and cost-effective implementation. In contrast with credit card statement acquisition systems, for example, the solution allows for more details and lower costs. Moreover, this approach may be used as a proof-of-purchase mechanism, in addition to the applications discussed above.

To take one specific example of applying the email confirmation methodology as a proof-of-purchase mechanism for a non-participating merchant, BookSellerTwo.com may wish to make a special offer only to consumers who are known to have made a purchase from BookSellerOne.com, a competitor of BookSellerTwo.com, within the last 30 days. To make these offers, BookSellerTwo.com could directly solicit email confirmations of BookSellerOne.com purchases. By applying the confirmation methods discussed herein, BookSellerTwo.com could them validate the authenticity of the purchase by examining the consumer's name and address and comparing it with the name and address of his or her credit card when making a new purchase at BookSellerTwo.com, and authenticating the email itself using DomainKeys or another approach. Moreover, an online marketer, such as the information gathering system discussed herein, may significantly simplify this process and reduce the likelihood of consumers “gaming” the offer (e.g., by intentionally splitting purchases between different merchants) by acting as an intermediary. The information gathering system may collects email confirmations without any specific offer other than points for submissions of the email confirmations, to take one possible embodiment. If BookSellerTwo.com, for example, approaches the information gathering system to find new customers, the information gathering system can identify members who have submitted purchase confirmations from BookSellerOne.com but have NOT submitted purchase confirmations from BookSellerTwo.com within the last 30 days. These members can then be targeted with a BookSellerTwo.com offer without diluting the target audience with members already purchasing from BookSellerTwo.com.

Generally with respect to the implementations discussed above, the system and methods for providing electronic feedback for transactions provide an improved approach to verifying that a member in fact performed an action for which he or she may claim points or another type of a reward. Moreover, applying the techniques discussed above may give members a stronger incentive to provide personal information about their shopping habits at large, as a way of supplementing behavioral data about the members and, additionally, as a way of gauging the prevalence and statistics about shopping activity associated with non-participating merchants by the member base.

To take one specific example of applying the email confirmation methodology as a proof-of-purchase mechanism for a non-participating merchant, BookSellerTwo.com may wish to make a special offer only to consumers who are known to have made a purchase from BookSellerOne.com, a competitor of BookSellerTwo.com, within the last 30 days. To make these offers, BookSellerTwo.com could directly solicit email confirmations of BookSellerOne.com purchases. By applying the confirmation methods discussed herein, BookSellerTwo.com could them validate the authenticity of the purchase by examining the consumer's name and address and comparing it with the name and address of his or her credit card when making a new purchase at BookSellerTwo.com, and authenticating the email itself using DomainKeys or another approach. Moreover, an online marketer, such as the information gathering system discussed herein, may significantly simplify this process and reduce the likelihood of consumers “gaming” the offer (e.g., by intentionally splitting purchases between different merchants) by acting as an intermediary. The information gathering system may collects email confirmations without any specific offer other than points for submissions of the email confirmations, to take one possible embodiment. If BookSellerTwo.com, for example, approaches the information gathering system to find new customers, the information gathering system can identify members who have submitted purchase confirmations from BookSellerOne.com but have NOT submitted purchase confirmations from BookSellerTwo.com within the last 30 days. These members can then be targeted with a BookSellerTw-o.com offer without diluting the target audience with members already purchasing from BookSellerTwo.com.

Generally with respect to the implementations discussed above, the system and methods for providing electronic feedback for interactions (e.g., business transactions, non-business transactions, various forms of commercial or non-commercial confirmation messages, communications related to various activities, etc.) provide an improved approach to verifying that a member in fact performed an action for which he or she may claim points or another type of a reward. Moreover, applying the techniques discussed above may give members a stronger incentive to provide personal information about their shopping habits at large, as a way of supplementing behavioral data about the members and, additionally, as a way of gauging the prevalence and statistics about shopping activity associated with nonparticipating merchants by the member base.

It will be further noted that although many of the examples discussed above refer to business entities, the methods of the present disclosure may similarly apply to non-business entities and other third-party entities. As one example, an enterprise system (such as the enterprise system 40 or a similar information gathering or online marketing system) may award users for forwarding to the enterprise system all email messages related to local school activities. The enterprise system may then use this information as an indication or evidence that a particular user is in fact associated with a certain school district, and may then use this indication when conducting promotions open only to parents whose children are enrolled in elementary schools, for example. At the same time, the enterprise system may receive funding for the promotion from a business entity such as a magazine, for example.

In summary, a method of reliably crediting a user for interacting with a participating business entity in a predefined manner may include receiving a copy of an electronic message sent to the user, wherein the electronic message includes information related to a transaction between the user and the participating business entity; verifying integrity of the electronic message; identifying an award rule associated with the transaction; and conditionally awarding the user based on the award rule and based on the information contained in the electronic message. The method may also include the electronic message being an e-mail message. The method may also include receiving the copy of the e-mail message including associating an e-mail address with an information gathering system, wherein the information gathering system maintains an award account uniquely associated with the user; and receiving the copy of the e-mail message at the e-mail address, wherein the user generates the copy by forwarding the electronic message to the e-mail address associated with the information gathering system.

The method may also include receiving the copy of the electronic message including providing a web form accessible to the user for entering data, wherein the web form is maintained by an information gathering system and wherein the information gathering system maintains an award account uniquely associated with the user; and receiving the copy of the electronic message via the web form; wherein the user generates the copy of the e-mail message by submitting the information contained in the e-mail message via the web form. The method may also include receiving the copy directly from the participating business entity. The method may also include providing the user with an e-mail address at an information gathering system, wherein the information gathering system maintains an award account uniquely associated with the user; and receiving the copy of the e-mail message at the e-mail address, wherein the participating business entity sends the e-mail message only to the e-mail address. The method may also include forwarding the e-mail message to a personal e-mail address associated with the user, wherein the personal e-mail address is associated with an e-mail provider different from the information gathering system.

The method may also include processing a digital signature included in the electronic message. The method may also include applying one of a public key or a private key to the digital signature, wherein the digital signature is generated by applying the other one of the private key or the public key, wherein the public key and the private key form a pair of cryptographic keys. The method may also include comparing the information related to the transaction to statistical data corresponding to a plurality of transactions associated with the participating business entity. The method may also include comparing a sequence number of a transaction identity associated with the transaction to one or more sequence numbers included in the statistical data. The method may also include comparing the information related to the transaction to statistical data corresponding to a plurality of past transactions associated with the user. The method may also include receiving the copy at an information gathering system maintaining an award account uniquely associated with the user; and wherein conditionally awarding the user according to the award rule includes updating the award account with a number of award points specific to the information gathering system and redeemable for a product or a service if the act of verifying the integrity of the electronic message does not produce a result indicative of the message having been tampered with. The method may also include receiving the copy at an information gathering system, wherein verifying the integrity of the electronic message includes comparing a format of the electronic message to a sample stored in a database associated with the information gathering system; and wherein the sample is uniquely associated the participating business entity. The method may also include sending a confirmation message to the user if the user has been awarded according to the award rule.

An information gathering system for use on the Internet is also contemplated, the system including a database storing a plurality of confirmation message samples, each of the plurality of confirmation message samples corresponding to one of a plurality of participating business entities working in cooperation with the information gathering system; and a transaction server communicatively coupled to the database, the transaction server including: a means for maintaining a balance of award points of each registered user, wherein the award points are redeemable for a product or a service; a first routine for receiving a copy of a confirmation message including information related to a transaction between a registered user and one of the plurality of participating business entities, wherein the confirmation message is delivered to the registered user; a second routine for comparing the copy of the confirmation message to the plurality of confirmation message samples to generate a match indication; a third routine for parsing a content of the copy of the confirmation message to identify a business rule associated with the transaction; and a fourth routine for updating the balance of award points according to the business rule and to the content of the copy of the confirmation message if the match indication has been generated.

The system may also include a fifth routine for applying a cryptographic algorithm to the copy of the confirmation message to verify the authenticity of the message. The system may also include an e-mail server coupled to the transaction server, the e-mail server including an e-mail account uniquely associated with the registered user, wherein the e-mail account is associated with a domain associated with the information gathering system. The system may also include a forwarding routine for forwarding the confirmation message to a second e-mail account of the user, wherein the second e-mail account is not associated withthe information gathering system. The system may also include a web server coupled to the transaction server; wherein the first routine receives a copy of a confirmation message from the web server, and wherein the registered user submits the copy of the confirmation message via a web page maintained by the web server.

Another method of reliably crediting a user for interacting with a participating business entity in a predefined manner is disclosed that includes: receiving an e-mail message from the participating business entity and addressed to the user, wherein the electronic message includes human-readable information related to a transaction between the user and the participating business entity; verifying the integrity of the e-mail message to determine whether an original content of the e-mail message has been modified; identifying an award rule associated with the transaction; and conditionally awarding the user according to the award rule and based on the information contained in the electronic message.

The method may also include applying statistical data to the e-mail message, wherein the statistical data includes one of a transaction history of the user or transaction history of the business entity to generate a probable match indicator; and flagging the e-mail message as suspicious if the probable match indicator indicates a deviation of the e-mail message from the statistical data. The method may also include directing the flagged e-mail message to a human operator; wherein the operator determines whether to award the user according to the award rule and based on the information contained in the electronic message. The method may also include comparing a format of the e-mail message to a sample format associated with the participating business entity.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method, in a computer system, for processing messages descriptive of an interaction between a user of the computer system and a third-party entity according to a predefined manner, the method comprising:
receiving an electronic message, wherein the electronic message includes interaction information associated with an interaction between the user and the third-party entity;
verifying integrity of the electronic message;
identifying a rule associated with the interaction, including:
identifying a condition associated with the rule; and
identifying an action to be performed if the condition is met; and
performing the action based on the rule and the interaction information in the electronic message if the condition is met.

2. The method of claim 1, wherein the electronic message is a copy of an e-mail message sent to the user from the third-party entity.

3. The method of claim 2, wherein the computer system is associated with an information gathering system, and wherein receiving the copy of the e-mail message includes:
associating an e-mail address with the information gathering system, wherein the information gathering system maintains an award account uniquely associated with the user; and
receiving the copy of the e-mail message at the e-mail address, wherein the user generates the copy by forwarding the electronic message to the e-mail address associated with the information gathering system.

4. The method of claim 2, wherein the computer system is associated with an information gathering system, and wherein receiving the copy of the electronic message includes:
providing a web form accessible to the user for entering data, wherein the web form is maintained by the information gathering system, and wherein the information gathering system further maintains an award account uniquely associated with the user; and
receiving the copy of the electronic message via the web form; wherein the user generates the copy of the e-mail message by submitting the information contained in the e-mail message via the web form.

5. The method of claim 2, wherein receiving the copy of the e-mail message includes receiving the copy directly from the third-party entity.

6. The method of claim 2, wherein the computer system is associated with an information gathering system, and wherein receiving the copy of the e-mail message includes:
providing the user with an e-mail address at the information gathering system, wherein the information gathering system maintains an award account uniquely associated with the user; and
receiving the copy of the e-mail message at the e-mail address, wherein the third party sends the e-mail message only to the e-mail address.

7. The method of claim 6, wherein receiving the copy of the e-mail message further includes forwarding the e-mail message to a personal e-mail address associated with the user, wherein the personal e-mail address is associated with an e-mail provider distinct from the information gathering system.

8. The method of claim 1, wherein the computer system is associated with an information gathering system that maintains an award account uniquely associated with the user; wherein the interaction information specifies a transaction between the user and the third-party entity; and wherein performing the action based on the transaction information in the electronic message includes conditionally allocating an award to the award account of the user based on the transaction specified in the electronic message.

9. The method of claim 8, wherein the third party is a participating business entity associated with a service provided by the information gathering system; and wherein identifying the rule associated with the interaction includes identifying a conditional award associated with the participating business entity and with the interaction.

10. The method of claim 8, wherein the third party is a non-participating business entity, the method further comprising using the interaction information to calculate a financial parameter.

11. The method of claim 10, wherein the financial parameter is one of a consumer spending metric, a brand purchasing habit metric, or a promotional metric.

12. The method of claim 1, wherein verifying the integrity of the electronic message includes processing a digital signature included in the electronic message.

13. The method of claim 12, wherein processing the digital signature includes applying one of a public key or a private key to the digital signature, wherein the digital signature is generated by applying the other one of the private key or the public key, wherein the public key and the private key form a pair of cryptographic keys.

14. The method of claim 1, wherein the interaction between the user and the third party is a business transaction, and wherein verifying the integrity of the electronic message includes comparing the information related to the business transaction to statistical data corresponding to a plurality of past interactions associated with the user.

15. The method of claim 1, wherein receiving the copy of the electronic message includes receiving the copy at an information gathering system that maintains an award account uniquely associated with the user; and wherein performing the action includes awarding the user according to the award rule includes updating the award account with a number of award points specific to the information gathering system and redeemable for a product or a service if the act of verifying the integrity of the electronic message does not produce a result indicative of the message having been tampered with.

16. The method of claim 1, wherein the computer system is associated with an information gathering system and includes a database; wherein the third party is a participating entity associated with a service provided by the information gathering system; wherein verifying the integrity of the electronic message includes comparing a format of the electronic message to a sample stored in the database; and wherein the sample is uniquely associated the participating entity.

17. The method of claim 1, wherein identifying a rule associated with the interaction includes identifying an award rule, the method further comprising sending a confirmation message to the user if the user has been awarded according to the award rule.

18. The method of claim 1, wherein the computer system is an information gathering and storage system that maintains an account associated with the user, and wherein performing the action based on the rule and the interaction information includes:
extracting the interaction information from the electronic message; and
associating the interaction information with the account associated with the user; the method further comprising:
receiving a retrieval request; and
retrieving the interaction information in response to the retrieval request.

19. The method of claim 18, wherein receiving the retrieval request includes receiving the retrieval request from the user.

20. The method of claim 18, wherein receiving the retrieval request includes receiving the retrieval request from a fourth party authorized to obtain information related to the user.

21. The method of claim 18, wherein the interaction information includes a purchase receipt.

22. An information gathering system for use on the Internet, the system comprising:
a database storing a plurality of confirmation message samples, each of the plurality of confirmation message samples corresponding to one of a plurality of participating third-party entities working in cooperation with the information gathering system; and
a transaction server communicatively coupled to the database, the transaction server including:
a means for maintaining a balance of award points of each registered user, wherein the award points are redeemable for a product or a service;
a first routine for receiving a copy of a confirmation message including information related to a transaction between a registered user and a third-party entity, wherein the confirmation message is delivered to the registered user;
a second routine for comparing the copy of the confirmation message to the plurality of confirmation message samples to generate a match indication;
a third routine for parsing a content of the copy of the confirmation message to identify a rule associated with the transaction; and
a fourth routine for updating the balance of award points according to the rule and to the content of the copy of the confirmation message if the match indication has been generated.

23. The system of claim 22, wherein the transaction server further includes a fifth routine for applying a cryptographic algorithm to the copy of the confirmation message to verify the authenticity of the message.

24. The system of claim 22, further comprising an e-mail server coupled to the transaction server, the e-mail server including an e-mail account uniquely associated with the registered user, wherein the e-mail account is associated with a domain associated with the information gathering system.

25. The system of claim 24, wherein the e-mail server further includes a forwarding routine for forwarding the confirmation message to a second e-mail account of the user, wherein the second e-mail account is not associated with the information gathering system.

26. The system of claim 22, further comprising a web server coupled to the transaction server; wherein the first routine receives a copy of a confirmation message from the web server, and wherein the registered user submits the copy of the confirmation message via a web page maintained by the web server.

27. The system of claim 22, wherein the plurality of participating third-party entities is a plurality of participating business entities; and wherein the third-party entity is one of the plurality of participating business entities.

28. The system of claim 22, wherein the third-party entity is not associated with the information gathering system; the system further comprising:
a fifth routine for collecting transaction information related to non-participating third-party entities based on the copy of the confirmation message received by the first routine; and
a sixth routine for providing the collected transaction information related to non-participating third-party entities in response to receiving an authorized request.

29. A method in a computer system of reliably performing a predetermined action associated with a user that interacts with a participating third-party entity in a predefined manner, the method comprising:
receiving an e-mail message from the participating third-party entity and addressed to the user, wherein the electronic message includes human-readable information related to a communication between the user and the participating business entity;
verifying the integrity of the e-mail message to determine whether an original content of the e-mail message has been modified;
identifying a rule associated with the transaction; and
conditionally performing an action associated with the rule according to the rule and based on the information contained in the electronic message.

30. The method of claim 29, wherein the communication specifies a transaction, and wherein verifying the integrity of the e-mail message includes:
applying statistical data to the e-mail message, wherein the statistical data includes one of a transaction history of the user or transaction history of the participating third-party entity to generate a probable match indicator; and
flagging the e-mail message as suspicious if the probable match indicator indicates a deviation of the e-mail message from the statistical data.

31. The method of claim 30, wherein verifying the integrity of the e-mail message further includes directing the flagged e-mail message to a human operator; wherein the operator determines whether to award the user according to the award rule and based on the information contained in the electronic message.

32. The method of claim 31, wherein verifying the integrity of the e-mail message further includes comparing a format of the e-mail message to a sample format associated with the participating third-party entity.

33. The method of claim 29, wherein the communication specifies a transaction and includes a sequence number; and wherein verifying the integrity of the e-mail message includes comparing the sequence number to one or more previously stored sequence numbers associated with the third-party entity.

34. The method of claim 29, wherein the third-party entity is a business entity associated with a demographic information collection service; wherein the communication between the user and the business entity specifies a consumer transaction; wherein identifying a rule associated with the transaction includes identifying an award rule; and wherein conditionally performing the action associated with the rule includes awarding the user according to the consumer transaction.

35. The method of claim 29, wherein the third-party entity is a business entity associated with a demographic information collection service; wherein the communication between the user and the business entity specifies a consumer transaction; the method further comprising:
storing the consumer transaction in an account associated with the user; and
providing the consumer transaction to the user upon request.

36. The method of claim 29, further comprising:
receiving a plurality of e-mail messages from participating third-party entities and addressed to the user; and
generating demographic information related to the user based on the plurality of e-mail messages.
